(19) United States
(12) Patent Application Publication
(10) Pub. No.: US 2009/0020411 A1
(43) Pub. Date: Jan. 22, 2009

(54) Laser pyrolysis with in-flight particle manipulation for powder engineering

(76) Inventors: Dean M. Holunga, Morgan Hill, CA (US); William E. McGovern, Lafayette, CA (US); Robert B. Lynch, Livermore, CA (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 12/077,076

(22) Filed: Mar. 14, 2008

Related U.S. Application Data
(60) Provisional application No. 60/961,429, filed on Jul. 20, 2007.

(51) Int. Cl. B01J 19/12

(52) U.S. Cl. 204/157.41; 422/186

(57) ABSTRACT

Laser pyrolysis apparatuses can provide for the engineering of product inorganic particles in-flight through the use of jet inlets that introduce a composition, such as an inert gas or a surface modifying composition, at high velocity. Under strong mixing conditions, the inorganic particle flow can be manipulated while also reducing particle agglomeration. These strong mixing apparatuses have been found to be effective at forming high quality crystals with structures that inherently grow relatively slowly through the slowing of the quenching process to maintain the crystal development until a desired high degree of crystallinity is achieved. Also, the surface chemistry of the particles can be manipulated in the flow to engineer desired inorganic particle surface chemistry.

### CROSS REFERENCE TO RELATED APPLICATIONS

This application claims priority to U.S. Provisional Patent Application Ser. No. 60/961,429 to Holunga et al., filed Jul. 20, 2007, entitled “Laser Pyrolysis with In-Flight Particle Manipulation for Powder Engineering,” incorporated herein by reference.

### FIELD OF THE INVENTION

The invention relates to particle production in a flow with the reaction driven by a light beam in which the product particle stream is mixed with other gases to influence the ultimate powder properties. The invention further relates to reactor apparatuses that are designed to mix compositions with particles synthesized in the reactor in-flight.

### BACKGROUND OF THE INVENTION

Advances in a variety of fields have created a demand for many types of new materials. In particular, inorganic powders can be used in the production of a range of commercial products including, for example, electronic devices, optical devices and electro-optical devices. Similarly, technological advances have increased the demand for improved material processing with strict tolerances on processing parameters to improve performance of devices while keeping down costs.

As miniaturization continues, material processing similarly falls within stricter tolerances with respect to the dimensions of the structures. Current integrated circuit technology already requires tolerances on processing dimensions on a submicron scale. The consolidation of mechanical, electrical and optical devices into integral components has created further demands on material processing with respect to the different compositions incorporated into a single structure. Thus, there is a demand for nanoscale materials with selected properties suitable for the particular applications.

### SUMMARY OF THE INVENTION

In a first aspect, the invention pertains to a reactor comprising a reaction chamber, a precursor delivery system, a light source, a product flow conduit and a first modification element. The precursor delivery system comprises an inorganic precursor source operably connected to a nozzle directed into the reaction chamber wherein the nozzle has a non-circular opening characterized by an elongated dimension. The light source is configured to deliver a beam of light through the reaction chamber to intersect with flow from the nozzle at a light reaction zone. The product flow conduit has a non-circular cross section characterized by elongated sides and a width between the elongated sides. In general, the conduit is configured to receive a particulate product flowing from the light reaction zone. The first modification element is configured to direct a mixing flow into the product flow conduit, and the first modification element comprises one or more inlets connected to a fluid source wherein the total area of the inlets is no more than about 0.15 times the cross section of the product flow conduit at the first modification element.

In a further aspect, the invention pertains to a method for moderating the temperature of flow of product particles in a reactor to control the crystal structure of the product particles. The method comprises mixing inert gas with a product particle flow in which the temperature of the inert gas is selected to achieve a desired particle crystal structure. The particles are synthesized within the flow by the reaction of a reactant flow with the reaction driven by an intense light beam at a light reaction zone. The flow proceeds from a reactant inlet through the light reaction zone with the product particles continuing in the flow to a particle collector. Generally, the measurable crystal structure of the collected particles is changed by the mixing with the inert gas.

In other aspects, the invention pertains to a method for modifying the surface chemistry without coating the particles. The method comprises mixing a selected composition with a product particle flow in which the composition is selected change the chemical properties of the flow to result in modified surface chemistry of the inorganic particles. The particles are synthesized within the flow by the reaction of a reactant flow with the reaction driven by an intense light beam at a light reaction zone. The flow proceeds from a reactant inlet through the light reaction zone with the product particles continuing in the flow to a particle collector.

### BRIEF DESCRIPTION OF THE DRAWINGS

FIG. 1 is a schematic, fragmentary side view of a laser pyrolysis apparatus modified to enable mixing of selected compositions with inorganic particle in the product flow.

FIG. 2 is a schematic side view of a laser pyrolysis reaction chamber with an elongated reactant inlet for a high throughput based on a sheet of flow.

FIG. 3 is a schematic diagram of a reactant delivery system with a gas delivery subsystem, a vapor delivery subsystem and a mixing subsystem.

FIG. 4 is a sectional front view of an aerosol delivery system in which the section is taken along line 4-4 of the insert showing a top view of the aerosol delivery system.

FIG. 5 is a sectional side view of the aerosol delivery system of FIG. 4 taken along line 5-5 of the insert of FIG. 4.

FIG. 6 is a perspective view of a further embodiment of an elongated reaction chamber for performing laser pyrolysis.

FIG. 7 is a cut away, side view of the reaction chamber of FIG. 6.

FIG. 8 is another embodiment of a laser pyrolysis apparatus with an elongated reactant nozzle with a particle transport section having four modification stations.

FIG. 9 is a sectional, perspective view of the particle transport section of the laser pyrolysis apparatus of FIG. 8.

FIG. 10 is a perspective view of a connecting collar that connects the particle transport section of FIG. 9 with a particle collection system.

FIG. 11 is a sectional view of the collar of FIG. 10, taken along the line 11-11 of FIG. 10.

FIG. 12 is a first configuration of a modification element with inlet jets for mixing a composition with the flow through the modification element.

FIG. 13 is an alternative configuration of a modification element with inlet jets.

FIG. 14 is a sectional top view of a modification element based on a knife slit taken along line 14-14 of FIG. 15.

FIG. 15 is a side sectional view of the modification element of FIG. 14 taken along line 15-15 of FIG. 14.

FIG. 16 is a plot of collection rate as a function of mixing flow for a set of particle production runs involving synthesis of TiO₂.

FIG. 17 is a plot of flow conduit temperature as a function of time for 6 different mixing flow rates.

FIG. 18 is a plot of BET particle surface area as a function of mixing flow rates for the particle production runs of FIG. 16.

FIG. 19 is a plot of the ratio of mixing flow to process gas flow as a function of mixing flow for a set of eight particle synthesis runs.

FIG. 20 is a plot of particle collection rate as a function of mixing gas flow rate for nine particle synthesis runs.

FIG. 21 is a plot of BET particle surface area as a function of mixing gas flow rate for the nine particle synthesis runs of FIG. 20.

FIG. 22 is a plot of crystalline phase of TiO₂ as a function of mixing gas flow rate for eight of the particle synthesis runs of FIG. 20.

FIG. 23 is a plot of amounts of nitrogen gas and clean dry air that make up a total of 32 standard liters per minute (slm) of mixing flow used for three runs of TiO₂ nanoparticle synthesis.

FIG. 24 is a plot of particle collection rate as a function of clean dry air flow for the three runs of FIG. 23.

FIG. 25 is a plot of crystalline phases of TiO₂ for the three particle synthesis runs of FIG. 23.

FIG. 26 is a plot of three x-ray diffractograms for samples form the three particle synthesis runs of FIG. 23.

FIG. 27 is a plot of amounts of nitrogen gas and clean dry air that make up a total of 32 standard liters per minute (slm) of mixing flow used for five additional runs of TiO₂ nanoparticle synthesis.

FIG. 28 is a plot of particle collection rate as a function of clean dry air flow rate for the five particle synthesis runs of FIG. 27.

FIG. 29 is a plot of BET particle surface area as a function of clean dry air flow rate for the five particle synthesis runs of FIG. 27.

FIG. 30 is a plot of crystalline phases of TiO₂ for the five particle synthesis runs of FIG. 27.

FIG. 31 is a plot of x-ray diffractograms for the samples from the five particle synthesis runs of FIG. 27.

FIG. 32 is a plot of crystalline phases for repeats of the samples presented in FIG. 30.

FIG. 33 is a plot of particle collection rates as a function of mixing gas flow rate for room temperature mixing gas and for heated mixing gas.

FIG. 34 is a plot of BET particle surface area as a function of mixing gas flow rates for room temperature mixing gas and for heated mixing gas.

FIG. 35 is plot of temperature at a location in the flow channel as a function of mixing gas flow rate for room temperature mixing gas and for heated mixing gas.

FIG. 36 is a plot of crystalline phase as a function of mixing flow for unheated mixing gas for a particular embodiment.

FIG. 37 is a plot of crystalline phase as a function of mixing flow for heated mixing gas for an embodiment corresponding to conditions used to generate FIG. 36.

FIG. 38 is a transmission electron micrograph of a representative TiO₂ sample synthesized with unheated mixing gas.

FIG. 39 is a plot of the particle size distribution for the particles from FIG. 38 as a function of the log of the particle size along with a plot of a least squares log-normal fit.

### DETAILED DESCRIPTION OF THE INVENTION

In-flight manipulation of particles synthesized in a laser pyrolysis reactor can be used effectively to form particles with selected desired properties for particles collected from the reactors as powders. For example, inert gas can be mixed with the product flow to modulate the temperature of the product particle flow. The inert gas can have a selected temperature to influence further thermal manipulation of the particles. The heating or cooling of the particles can influence the resulting properties of the particles, such as the crystal structure, and the mixing of fluid with the particles can inhibit particle agglomeration such that the character of the resulting powders can be engineered to specification, such as with respect to average particle size, uniformity and/or surface area. In some embodiments, the particles are interacted in-flight with compositions that can modify the surface chemistry of the particles, which may be performed prior to and/or following thermal manipulation such that the surface modification can proceed under appropriate conditions. Suitable apparatuses can be effectively designed to provide flexibility with respect to introduction of compositions to mix rapidly with the product particle flow at a selected location along the product flow, while achieving high throughputs.

Laser pyrolysis is a flow based technique in which the flow proceeds through a reaction chamber from an inlet to an outlet. Along the path of the flow a reaction takes place at a light reaction zone. The inlet is fluidly connected to a reactant delivery system that delivers a reactant flow into the reaction chamber through one or more inlets to initiate the flow. The light reaction zone overlaps with a region where a light beam intersects with the reactant flow. Energy from the light beam is absorbed by the flow and drives a reaction in the flow resulting in particle formation. The product particles continue in the flow to a collector. Generally, a pump or other mass flow device maintains flow through the system and maintains the pressure in the reactor within a desired range such that the particles have selected properties. As described herein, the manipulation of the temperature of the product flow downstream from the light reactive zone can be a powerful technique to influence the properties of the collected particles.

A basic feature of successful application of laser pyrolysis for the production of inorganic particles is production of a reactant stream containing one or more appropriate metal/metalloid precursors. A source of element(s) with high electron affinity should also be provided. For example with respect to metal/metalloid oxides, the oxygen element can be bonded within the metal/metalloid precursors and/or can be supplied by a separate oxygen source, such as molecular oxygen. Similarly, unless the metal precursors and/or the oxygen source are an appropriate radiation absorber, an additional radiation absorber can be added to the reactant stream.

In laser pyrolysis, the reactant stream is pyrolyzed by an intense light beam, such as a laser beam. While a laser beam is a convenient energy source, other intense light sources can be used in laser pyrolysis. Laser pyrolysis provides an energy source that stabilizes or ignites reactions that otherwise may be kinetically or thermodynamically unfavorable, enabling the formation of materials and/or material phases that are difficult to achieve otherwise. As the reactant stream leaves the light beam, the inorganic particles are rapidly quenched.

Product materials of interest include amorphous materials, crystalline materials and combinations thereof. Amorphous materials possess short-range order that can be very similar to that found in crystalline materials. In crystalline materials, the short-range order comprises the building blocks of the long-range order that distinguishes crystalline and amorphous materials. In other words, translational symmetry of the short-range order building blocks found in amorphous materials creates long-range order that defines a crystalline lattice. For example, silica glass is an amorphous material comprised of (SiO₄)⁴⁻ tetrahedra that are bonded together at irregular bond angles. The regularity of the tetrahedra provides short-range order but the irregularity of the bond angles prevents long-range order. In contrast, quartz is a crystalline silica material comprised of the same (SiO₄)⁴⁻ tetrahedra that are bonded together at regular bond angles to form long-range order which results in a crystalline lattice. In general, the crystalline form is a lower energy state than the analogous amorphous form. Relaxation of energy provides a driving force towards formation of long-range order. In other words, given sufficient atomic mobility and time, long-range order can form.

In laser pyrolysis, a wide range of inorganic materials can be formed in the reactive process. Based on kinetic principles, higher quench rates inhibit crystallization and may result in amorphous particle retention while slower quench rates may provide additional time as well as thermal energy, which favor crystalline particle formation. Faster quenching can be accomplished by accelerating the removal of thermal energy from the particles after they have passed through the reaction zone. In addition, some precursors may favor the production of amorphous particles while other precursors favor the production of crystalline particles of similar or equivalent stoichiometry. Low laser power can also favor formation of amorphous particles. The formation of amorphous oxides is described further in U.S. Pat. No. 6,106,798 to Kambe et al., entitled “Vanadium Oxide Nanoparticles,” incorporated herein by reference. However, crystalline materials are of particular interest for phosphor applications, and the phosphor particles specifically described herein are highly crystalline.

Based on traditional understanding of the laser pyrolysis process, the particles are rapidly quenched following their flow out from the light reaction zone, and in some embodiments, the subsequent self-propagating exothermic reaction zone. While this is true, the picture is somewhat incomplete based on the experiments described herein. The stoichiometry of the particles is generally fixed in the light reaction zone, which has a very small spatial extent. Furthermore, the driving force toward a particular crystal structure is also initiated in the reaction zone. However, many materials have different available crystal structures for a particular stoichiometry, and some of the crystal structures can have a significant kinetic timeframe for formation that extend the crystallization process out from the reactive zone. Since the thermal conditions change outside of the light reaction zone due to quenching, the changing conditions can correspondingly change the driving force the formation of particular crystalline structures. Thus, without intervention, the resulting crystallinity may be poor for certain crystal structures with amorphous domains or alternative crystal structures in addition to the dominant crystal structure. Thus, manipulation of the product flow can have a significant effect on the particle properties.

The thermal manipulation of the flow generally can be performed through the delivery of an inert gas at a selected temperature. Another dimension of the thermal manipulation relates to the position of the delivery of the inert gas. The position of the introduction of the inert gas relates to the time of the particle evolution beyond the reaction zone since the flow rate correlates the time and the position. The volume and temperature of the inert gas determine the change in thermal load of the flow. As described further below, the composition mixed with the product flow can be delivered under conditions in which rapid and thorough mixing occurs.

In some embodiments, particle formation can take place in no more than about 10 milliseconds (ms). On the other hand, in some embodiments, crystal formation can take place in a time scale on the order of about 25 ms to about 100 ms or longer. For slowly forming crystal structures, rapid quenching can lead to poor crystal quality characterized by significant strain, a large number of defects and the like. In some embodiments, the formation of covalently bonded, i.e., so-called hard aggregates, takes place at temperatures similar to rapid crystal formation. However, weak or “soft” agglomerates, e.g. van der Waals bonded, that are thought to be easier to subsequently separate can form at lower temperatures under the right conditions in the product flow. The use of an inert heating gas can heat the particles to achieve improved crystal formation while diluting the particles to inhibit Brownian coagulation and the subsequent hard agglomeration. When sufficient dilution is achieved, it provides time for desired property formation before inherent thermal loss mechanisms reduce the temperature to where predominantly soft agglomerates form. The formation of rutile titanium dioxide, i.e., titania or TiO₂, is a particular example of crystal formation that can be improved by the processes described herein. Upon the formation of good crystal structures for the particles, the particles have faceted surfaces corresponding to the crystal lattice, which are evident in transmission electron micrograph (TEM) images.

The surface properties of the particles strongly influence their further processing. For highly crystalline particles, the surface terminates the crystal structure, which may or may not result in strain. In particular, the surface can involve terminal groups that introduce strain, such as bridged oxygen atoms, e.g. M-O-M, where M is a metal/metalloid of the crystal, mono-valent atoms, such as H bonded to an oxygen atom or a halogen atom bonded to a metal/metalloid atom such that the surface terminates with little or no strain. The surface chemistry can be a function of the reaction conditions and the chemicals in the reactant flow. Modification of the particle surface chemistry can be performed in-flight through the introduction of appropriate compositions to the flow. Thermal manipulation of the particles can be used to maintain, increase or decrease the particle temperature to facilitate subsequent modification of the surface chemistry while correspondingly diluting the particles to reduce unwanted agglomeration. Similarly, the modification compound can be introduced at a suitable temperature to support the resulting particle surface modification.

The mixing of a composition under good mixing conditions can also reduce agglomeration as well as thermally manipulate the product flow and/or modify the surface chemistry. Agglomeration can occur due to inelastic collisions in the product flow if the translational energy can be transferred to other particles and/or to internal energy. Strong mixing of compositions with the product flow dilutes the flow and adds translational energy that makes it significantly harder for collisions between product particles to result in agglomerates. If the particles are further cooled close to the collector, it is thought that the subsequent “cold” collection of the particles results in very weak attractive forces between the particles that are more likely to be overcome during a dispersion process. Thus, the mixing of the product particles in the flow with a composition under strong mixing conditions can further improve the quality of the collected particles.

The apparatus generally is designed to facilitate the manipulation of the product particle flow downstream from the reaction zone. The composition generally is introduced through one or more inlets at a manipulation element along the flow at a suitable position downstream from the reaction zone. The inlets generally are configured to introduce the composition at an orientation to induce mixing with a flow through the product stream and with a significantly higher velocity than the flow through the product stream. For example, the inlet can be configured to introduce a mixing composition orthogonal to or angled slightly upstream to the product flow to obtain improved mixing. To obtain a volumetric inlet flow that is reasonable relative to the volumetric product stream flow while having a high velocity relative to the product flow velocity, the area of the inlets at a mixing station generally can be significantly less than the area of the apparatus confining the product stream flow.

In some embodiments, the inlets generally comprise a plurality of jets that introduce a fluid composition into the flow under strong mixing conditions. The inlets are operably connected to a suitable supply and, if desired, appropriate thermal temperature conditioners that adjust the temperature of the composition. The diameters of the jets and the flow through the jets can be selected to provide good mixing. In particular, due to the diameters of the jets and the flow volume, the velocity of the fluid through the jets is generally relatively high so that the resulting mixture is well mixed due to the energy delivered by the added fluid. In other embodiments, the inlets comprise a thin knife slit that similarly have a small orifice area that provides the inlet composition at a high velocity and momentum to induce good mixing with the product flow. Combinations of knife slits, small orifice jets and the like can be used as appropriate to achieve desired degrees of mixing.

To obtain higher throughput with a laser pyrolysis process, apparatuses have been designed with an elongated reactant inlet. The elongated reactant inlet is aligned such that a sheet of reactant flow passes through a light beam to form a corresponding sheet of product flow. The manipulation of this product flow should correspondingly account for the geometry of the product flow. In particular, one or more inert gas inlets can be configured around the flow channel that is correspondingly configured to accept the flow from the reaction zone. If appropriately positioned with inlets that are distributed around the circumference of the flow channel, the inlets result in good mixing of the product particle flow with the non-circular geometry of the flow.

The reaction chamber can be configured around the reaction zone. In some embodiments, the chamber can be made to conform to the size of the flow including any shielding gas with a relatively low amount of dead volume within the chamber. Dead volume can provide locations of recirculating flow, in which particles may agglomerate and sinter to undesirably large size before being re-entrained into the product flow or contaminating the adjoining surfaces of the dead volume. Also, the conformation of the reaction chamber to the flow can reduce the overall apparatus size as well as the footprint of the apparatus and the amount of material incorporated into the apparatus.

Generally, the apparatus comprises a reactant delivery system, a reaction chamber, a product particle manipulation element and a collection system. The reactant delivery system generally comprises storage containers for the one or more reactants and may further have inert gas sources to provide a diluent gas combined with the reactants. The interface between the reactant delivery system and the reaction chamber is generally well defined with an inlet or nozzle at the interface. The inlet or nozzle initiates the flow within the reaction chamber. The shape of the flow generally is strongly influenced by the shape and size of the inlet/nozzle.

The reaction chamber has a light beam path traversing the reaction chamber and configured to intersect with the reactant flow. A relatively well defined reaction zone overlaps with the region of intersection of the light beam and the reactant flow. The precise boundaries of the reaction zone are determined by the reaction conditions and the particular reactants, but the light-driven reaction is generally completed in a relatively small region in a short time period.

The collector comprises a structure to harvest the particles from the flow. The harvested particles can be then directed to desired applications. Suitable collectors can use some form of membrane to separate a product plenum from a filtered plenum, or electrostatic collector can remove particles form the flow, or other suitable mechanism can be used for harvesting. A pump or other mass movement device generally is used to maintain the flow and the desired pressures within the system.

With respect to manipulation of the product particles to engineer the resulting properties, the portion of the system from the light reaction zone to the collector is where these functions are performed. The system can be designed with a fixed configuration for the manipulation elements for a dedicated apparatus to repeatedly form a single product. However, in other embodiments, the system comprises the ability to select the parameters with respect to timing of the mixing process so that a particular product can be selected in the apparatus. In particular, the apparatus can comprise a plurality of manipulation elements of which only a portion of these may be used that are selected based on the particular manipulation desired and the timing of the manipulation with respect to time from the reaction zone. A manipulation element generally may be located along the reaction chamber downstream from the reaction zone or along a distinct section of a particle transport section leading to the collector.

Inorganic particles generally include metal and/or metalloid elements in their elemental form or in compounds. Specifically, inorganic particles can include, for example, elemental metal or elemental metalloid, i.e. un-ionized elements, alloys thereof, metal/metalloid oxides, metal/metalloid nitrides, metal/metalloid carbides, metal/metalloid sulfides, metal/metalloid silicates, metal/metalloid phosphates or combinations thereof Metalloids are elements that exhibit chemical properties intermediate between or inclusive of metals and nonmetals. Metalloid elements include silicon, boron, arsenic, antimony, and tellurium. When the terms metal or metalloid are used without qualification, these terms refer to a metal or metalloid element in any oxidation state and in elemental form or in a composition. When a metal or metalloid composition is recited, this refers to any composition with one or more metal metalloid elements in oxidized, i.e., non-elemental, form with corresponding elements to provide electrical neutrality. Reference to elemental metal or elemental metalloid refers to the elemental form of the element, i.e., the unoxidized, M⁰, where M represents the metal/metalloid.

Desirable collections of metal/metalloid composition, for example metal/metalloid oxide, particles can have an average diameter no more than a micron and high uniformity with a narrow distribution of particle diameters. To generate desired submicron metal/metalloid composition particles, laser pyrolysis can be used effectively. Specifically, laser pyrolysis has been found to be an excellent process for efficiently producing submicron (less than about 1 micron average diameter) and nanoscale (less than about 100 nm average diameter) metal/metalloid composition particles with a narrow distribution of average particle diameters. A large variety of different types of inorganic particles can be produced using the approaches described herein.

In laser pyrolysis, the particles emerge from the light reaction zone and are rapidly quenched. The conditions in the light reaction zone drive the particles to a certain stoichiometry and crystal structure. However, for some kinetically limited crystal structures, the particles require a moderate amount of time to develop the particular crystal structure. Due to the rapid quenching, the particle structure can get frozen into a particular structure before the crystal structure can fully form. Furthermore, the surface chemistry is determined by the properties of the flow in the reaction zone, but these reaction conditions also influence the stoichiometry and crystal structure. Therefore, to obtain particles with desired properties, such as crystal structure and surface chemistry, it may be difficult to fully determine these product particle properties through manipulating the conditions in the light reaction zone, especially while obtaining desired levels of throughput.

It has been realized that the crystal structure of the collected particles can be changed or improved through the thermal manipulation of the particles within the flow past the light reactive zone. In particular, inert gas can be added at a selected temperature to increase the quenching or to add heat so that the crystal forms of the particles can complete formation into a high quality crystal structure. This continued crystal development can be useful to fully develop the crystal structure so that other phases do not form in competition with desired forms and amorphous regions are not frozen into the particles. Similarly, lattice imperfections can be driven from the particles through effectively in-flight annealing. While the crystal structure of the inorganic particles can be changed and/or improved through a separate heating step following collection of the particles, this involves a separate processing step, some crystal structures are difficult to form in a post collection heating step, and the heating process conditions generally should be controlled over a certain range to avoid undesired particle fusing. Therefore, it is desirable to reduce or eliminate post collection heating steps.

Similarly, the surface chemistry of the particles can also be selected in-flight so that the particles have desired properties for further processing after collection. The chemistry in the reaction zone as well as the precursor composition generally determines the surface chemistry of the product particles. Thus, the surface chemistry of the particles can be influenced in the flow through thermal and/or chemical manipulation. For example, compositions can be added to the flow to contribute desired elements into the flow that can react at the surface to form desired surface terminal groups. For example, water can contribute —OH groups that can terminate metal/metalloid oxide particles, ammonia can contribute —NH₂ groups to terminate nitride particles and HX and X₂, where X is a halogen, F, Cl, Br or I atom, can contribute halogen atoms to terminate a range of particle types.

The addition of inert gas and/or compositions for surface chemistry engineering can be performed through inlets that introduce the compositions at relatively high velocity to provide very good mixing with the flow. Good mixing with the flow provides corresponding improved uniformity of the results with respect to the product particle properties being engineered by the addition to the flow. However, the introduction of the high velocity composition into the flow also produces a relatively high level of translational kinetic energy into the mixed flow that rapidly mixes with the product gas, diluting the particle concentration, and temporarily suppressing agglomeration of the particles. Specifically, agglomeration does not result unless sufficiently inelastic collisions transfer translational energy into internal energy or translational energy of ancillary particles in the flow, which is less probably if the overall relative translational energy in the flow energy is increased. Thus, agglomeration of the particles can be decreased significantly until the particles are more completely cooled for collection.

In summary, the ability to inject strongly mixing compositions into the flow of a laser pyrolysis apparatus just downstream from the light reaction zone provides extremely versatile ability to adjust the properties of the product particles. In some embodiments, this provides for increased throughput to achieve higher production rate without sacrificing product particle properties. In other embodiments, this provides for producing particle that may be difficult or impossible to produce without the ability to manipulate the particles in-flight. At the same time, the introduction of strongly mixing compositions into the flow can further decrease or temporarily suppress undesirable particle agglomeration, as well as reduce or eliminate necking in agglomerates. Mixing also suppresses the formation of hot-spots in the reactor effluent and may eliminate or strongly suppress the “tail” of significantly larger particles that are commonly observed from ordinary flame pyrolysis reactors.

Laser Pyrolysis Apparatus with In-Flight Particle Manipulation

The laser pyrolysis apparatuses described herein are configured to provide good mixing of an additive composition with the product flow in the apparatus downstream from the reaction zone. The additive composition can be an inert gas in some embodiments to provide thermal management of the flow. In additional or alternative embodiments, the additive composition can be selected to modify the surface chemistry of the product particles. One or more inlets can be configured to deliver a composition at a desired location along the flow downstream from the light reaction zone to achieve desired product engineering. Furthermore, a plurality of modification elements can be used to perform multiple modification steps at different positions along the flow. High velocity inlet(s) can be configured to provide good mixing with the flow.

A reaction apparatus for in-flight particle engineering accommodates a flow path that provides for a reaction to form the inorganic particles as well as for mixing of the product inorganic particles with subsequent compositions in-flight to engineer the final product properties. A reactant delivery portion initiates a flow comprising precursors for the formation of the inorganic particles. Also, the reaction apparatus generally interfaces with auxiliary systems, such as systems to mix an appropriate composition with the product flow downstream from a light reaction zone where the product inorganic particles are formed. Once the inorganic particles are engineered for desired properties, a collector separates the product inorganic particles from the flow to terminate the in-flight process. The application of coating materials in-flight is described further in copending patent application Ser. No. 11/438,477 to Chiruvolu et al., entitled “In-Flight Modifications of Inorganic Particles Within a Reaction Product Flow,” incorporated herein by reference. This copending application describes the mixing of an inert gas with a product flow to quench the particles, but this application does not teach the particle engineering described herein or improved high momentum inlet(s) that provide a high level of mixing with the product flow. The application of coating materials can also be implemented along the inorganic particle modification described herein, in which the coating aspect is implemented as described in the '477 application noted above.

As described above, flow relates to a net movement of mass from one point to another. Generally, the flow path within the apparatus relating to in-flight processing extends from one or more inorganic particle reactant precursor inlets to a collector system. Along the flow, the inorganic particles are synthesized and the inorganic particles are engineered to have desired final properties. Generally, a negative relative-pressure device is used to maintain the flow through the apparatus along the flow path, although flow can be maintained from the positive pressure generated from composition delivery into the apparatus. Suitable negative relative-pressure devices include, for example, a pump, a blower, an aspirator/venturi, compressor, ejector or the like. If there is a plurality of inorganic particle precursor inlets, flow from these can be combined prior to inorganic particle production, which can involve, for example, the combination of reactants that are difficult to deliver through a single nozzle or of reactant that are reactive upon mixing so that they do not react significantly prior to entering the light reactive zone.

Laser pyrolysis has become the standard terminology for flowing chemical reactions driven by an intense radiation, e.g., light, with rapid quenching of product inorganic particles after leaving a reaction region formed by the radiation intersecting with the reactant flow. The name, however, is a misnomer in the sense that radiation from non-laser sources, such as a strong, incoherent light or other electromagnetic beam, can replace the laser. Also, the reaction is not a pyrolysis in the sense of a thermal pyrolysis. The laser pyrolysis reaction is not solely thermally driven by the exothermic combustion of the reactants. In fact, in some embodiments, laser pyrolysis reactions can be conducted under conditions where no visible light emissions are observed from the reaction, in stark contrast with pyrolytic flames.

The reaction conditions can determine the qualities of the particles produced by laser pyrolysis. The reaction conditions for laser pyrolysis can be controlled relatively precisely in order to produce inorganic particles with desired properties. For example, the reaction chamber pressure, flow rates, composition and concentration of reactants, radiation intensity, radiation energy/wavelength, type and concentration of inert diluent gas or gases in the reaction stream, temperature of the reactant flow can affect the composition and other properties of the product particles, for example, by altering the time of flight of the reactants/products in the reaction zone and the quench rate. Thus, in a particular embodiment, one or more of the specific reaction conditions can be controlled. The appropriate reaction conditions to produce a certain type of particles generally depend on the design of the particular apparatus. Some general observations on the relationship between reaction conditions and the resulting particles can be made.

Increasing the light power results in increased reaction temperatures in the reaction region as well as a faster quenching rate. A rapid quenching rate tends to favor production of higher energy phases, which may not be obtained with processes near thermal equilibrium. Similarly, increasing the chamber pressure also tends to favor the production of higher energy phases. Also, increasing the concentration of the reactant serving as the oxygen source, nitrogen source, sulfur source or other secondary reactant source in the reactant stream favors the production of particles with increased amounts respectively of oxygen, nitrogen, sulfur or other secondary reactant.

Reactant velocity of the reactant stream is inversely related to particle size so that increasing the reactant velocity tends to result in smaller particle sizes. A significant factor in determining particle size is the concentration of product composition condensing into product particles. Reducing the concentration of condensing product compositions generally reduces the particle size. The concentration of condensing product can be controlled by dilution with non-condensing, e.g., inert, compositions or by changing the pressure with a fixed ratio of condensing product to non-condensing compositions, with a reduction in pressure generally leading to reduced concentration and a corresponding reduction in particle size and vice versa, or by combinations thereof, or by any other suitable means.

Light power during laser pyrolysis also influences the inorganic particle sizes with increased light power favoring smaller particle formation, especially for higher melting temperature materials. Also, the growth dynamics of the particles have a significant influence on the size of the resulting particles. In other words, different forms of a product composition have a tendency to form different size particles from other phases under relatively similar conditions. Similarly, under conditions at which populations of particles with different compositions are formed, each population of particles generally has its own characteristic narrow distribution of particle sizes.

Inorganic particles of interest include, for example, amorphous particles, crystalline particles, combinations thereof and mixtures thereof. Amorphous inorganic particles possess short-range order that can be very similar to that found in crystalline materials. In crystalline materials, the short-range order comprises the building blocks of the long-range order that distinguishes crystalline and amorphous materials. In other words, translational symmetry of the short-range order building blocks found in amorphous materials creates long-range order that defines a crystalline lattice. In general, the crystalline form is a lower energy state than the analogous amorphous form. This provides a driving force towards formation of long-range order. In other words, given sufficient atomic mobility and time, long-range order can form. The surface properties or chemistry of the particles can be influenced by the reaction conditions, including, for example, the composition of the reactants as well as the reactor properties at the light reaction zone. Furthermore, the thermal manipulation techniques with or without further modification of the post synthesis chemical environment can engineer the surface chemistry appropriately.

In laser pyrolysis, a wide range of inorganic particles can be formed in the reactive process. Based on kinetic principles, higher quench rates favor amorphous particle formation while slower quench rates favor crystalline particle formation as there is time for long-range order to develop. Faster quenches can be accomplished with a faster reactant stream velocity through the reaction zone. In addition, some precursors may favor the production of amorphous particles while other precursors favor the production of crystalline particles of similar or equivalent stoichiometry. The formation of amorphous metal oxides particles and crystalline metal oxide particles with laser pyrolysis is described further in U.S. Pat. No. 6,106,798 to Kambe et al., entitled “Vanadium Oxide Nanoparticles,” incorporated herein by reference.

To form desired inorganic particles in the light-driven reaction process, one or more precursors generally supply the one or more metal/metalloid elements that are within the desired composition. The reactant stream generally would comprise the desired metal element(s) and, additionally or alternatively, metalloid element(s) to form the host material and, optionally, dopant(s)/additive(s) in appropriate proportions to produce product inorganic particles with a desired composition. Furthermore, additional appropriate precursor(s)/reactant(s) can supply other element(s) for incorporation into the product inorganic particles. The composition of the reactant stream can be adjusted along with the reaction condition(s) to generate desired product particles with respect to composition and structure. Based on the particular reactants and reaction conditions, the product particles may not have the same proportions of metal/metalloid elements as the reactant stream since the elements may have different efficiencies of incorporation into the particles, i.e., yields with respect to unreacted materials. However, the amount of incorporation of each element is a function of the amount of that element in the reactant flow, and the efficiency of incorporation can be empirically evaluated based on the teachings herein to obtain desired compositions. The designs of the reactant nozzles for radiation driven reactions described herein are designed for high yields with high reactant flows.

For the performance of laser pyrolysis, the energy absorbed from the light beam increases the temperature at a tremendous rate, many times the rate that heat generally would be produced by exothermic reactions under controlled condition(s). While the process generally involves nonequilibrium conditions, the temperature can be described approximately based on the energy in the absorbing region. The laser pyrolysis process is qualitatively different from the process in a combustion reactor where an energy source initiates a reaction, but the reaction is driven by energy given off by an exothermic reaction. Thus, while the light driven process for particle collection is referred to as laser pyrolysis, it is not a traditional pyrolysis since the reaction is not driven by energy given off by the reaction but by energy absorbed from a radiation beam. If necessary, the flow can be modified such that the reaction zone remains confined.

With suitable high throughput reactor designs, high inorganic particle production rates can be achieved. The particle production rate based on reactant delivery configurations described herein can yield particle production rates in the range(s) of at least about 0.1 g/h, in some embodiments at least about 10 g/h, in some embodiments at least about 50 g/h, in other embodiments in the range(s) of at least about 100 g/h, in further embodiments in the range(s) of at least about 250 g/h, in additional embodiments in the range(s) of at least about 1 kilogram per hour (kg/h) and in general up in the range(s) up to at least about 10 kg/h. A person of ordinary skill in the art will recognize that additional values of particle production rate within these specific values are contemplated and are within the present disclosure.

In general, these high production rates can be achieved while obtaining relatively high reaction yields, as evaluated by the portion of metal/metalloid nuclei in the flow that are incorporated into the product inorganic particles. In general, the yield can be in the range(s) of at least about 30 percent based on the limiting reactant, in other embodiments in the range(s) of at least about 50 percent, in further embodiments in the range(s) of at least about 65 percent, in other embodiments in the range(s) of at least about 80 percent and in additional embodiments in the range(s) of at least about 95 percent based on the metal/metalloid nuclei in the reactant flow. A person of ordinary skill in the art will recognize that additional values of yield within these specific values are contemplated and are within the present disclosure.

The laser pyrolysis apparatuses described herein generally comprise one or more particle modification elements or stations. The modification elements generally are placed at reasonable locations along the product flow to provide a desired level of mixing. In some embodiments, the apparatus has a plurality of modification elements located at different positions along the flow so that the timing for introduction of the modification composition can be selected through the corresponding selection of the position along the flow and/or to provide for the introduction of modification compositions at a plurality of locations along the flow.

In some embodiments, these elements generally comprise a plurality of spaced apart inlet jets to provide excellent mixing of a composition with the product flow in a very short time such that the particle properties can be efficiently engineered. The spaced apart inlet jets may or may not be symmetrically placed around the circumference of the product particle flow. In additional or alternative embodiments, a modification element can comprise one or more knife slits or the like for the introduction of strongly mixing composition into the flow. Similarly, a combination of jets and knife slits can be used to obtain desired levels of uniformity.

In general, the mixing of the modification composition with the product particle flow should not interfere with the reaction conditions at the light reaction zone so that the product particle properties can be determined by the conditions at the light reaction zone and the product particles are generally uniform. Thus, the flow conditions at the modification element can be appropriately selected, for example, with respect to total flow and design, to avoid interfering with the reaction conditions at the light reaction zone. Further empirical adjustment can be performed for a particular reaction process.

The modification elements can be located within the reaction chamber downstream from a light reaction zone or interfaced with a particle transportation section attached to the reaction chamber to receive the product flow and direct the product flow to a collector. In some embodiments, there may not be a clear demarcation between the reactor and a particle transportation section, and the notation of a division between these sections may not be significant for specifying many features of the processing described herein. The modification section can be associated with a product flow conduit, which can be part of the reaction chamber or a particle transportation section, that is characterized by elongated sides and a significantly smaller thickness between the adjacent elongated sides. The specific embodiments described below relate to such embodiments with a product flow conduit having an elongated dimension characterized with elongated sides.

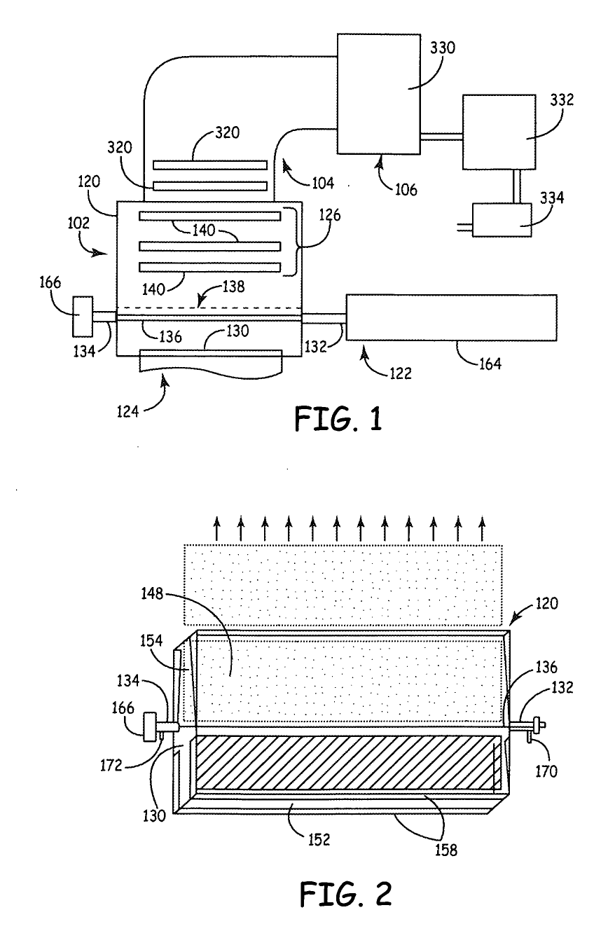

Referring to FIG. 1, modified inorganic particle production system 100 comprises a laser pyrolysis apparatus 102, particle transport section 104, and collection system 106. Laser pyrolysis apparatus 102 comprises a reaction chamber 120, an intense light delivery apparatus 122, a reactant delivery section 124 and an optional particle modifying section 126. Reaction chamber 120 confines the reaction for the formation of the inorganic particles. Reaction chamber 120 comprises a reactant inlet 130, a light inlet conduit 132, a light outlet conduit 134 that forms a light beam path 136 with light beam inlet 132, and a reaction zone 138 in the vicinity of and generally overlapping with the intersection of a light beam path 136 and the flow path of reactants from reactant inlet 130. Reaction chamber 120 can interface with particle modification section 126 at one and/or more modification elements 140, which can be inlet nozzles or radiation sources.

Laser pyrolysis systems suitable for producing commercial quantities of product particles can have an inlet elongated along the direction of the light beam propagation such that a sheet of reactants flow into the reaction zone to form a sheet of product particle in a product flow. Generally, essentially the entire reactant flow passes through the light beam. Large throughputs are achievable with these systems, which are able to efficiently produce high quality particles over appropriately long run time. Reaction chamber designs for large throughputs are described further in U.S. Pat. No. 5,958,348 to Bi et al., entitled “Efficient Production of Particles By Chemical Reaction,” incorporated herein by reference. Reaction chamber 120 is configured with an elongated reactant inlet for the achievement of a higher throughput.

A fragmentary view of reaction chamber 120 is shown schematically in FIG. 2, which shows reaction chamber 120 generating a sheet of product flow 148 from a sheet of reactant flow 150. This chamber is shown in this view truncated a short distance above the reaction zone. A reactant inlet 152 leads to main chamber 154. Reactant inlet 152 conforms generally to the shape of main chamber 154. Reactant inlet 152 is connected to reactant delivery section 124. Shielding gas inlets 158 can be located on both sides of reactant inlet 152. Shielding gas inlets are used to form a blanket of inert gases on the sides of the reactant stream to inhibit contact between the chamber walls and the reactants or products.

Referring to FIG. 2, tubular sections 132, 134 extend from the main chamber 154. Tubular sections 132, 134 respectively connect with light source 164 and beam dump/light meter 166 to define a light beam path 168 through the reaction chamber 150. Tubular sections 132, 134 can comprise inert gas inlets 170, 172 for the introduction of inert gas into tubular sections 132, 134 to reduce contamination of optical components. Inert gas inlets 170, 172 generally are connected to a suitable inert gas source.

The dimensions of elongated reaction chamber 154 and reactant inlet 152 can be designed for highly efficiency product composition production. The reaction zone is located within the reaction chamber in the vicinity of the intersection of the reactant flow with the light beam path. Reasonable elongated dimensions for reactant inlet 152, when used with a CO₂ laser with a power in the several kilowatt range, are from about 5 mm to about 2 meters or in further embodiments from about 2 centimeters to about 1 meter. In general, the inlet generally has a thickness from about 1 mm to about 10 centimeters (cm) and in further embodiments from about 2 mm to about 2 cm. Furthermore, the aspect ratio of the inlet opening, which is the elongated dimension divided by the thickness, can range from about 2 to about 1000 and in other embodiments from about 5 to about 200. A person of ordinary skill in the art will realize that additional ranges of inlet dimensions and aspect ratios are contemplated and are within the present disclosure.

While shown as a rectangular inlet, the edges and corners of an elongated reactant inlet can be rounded somewhat while maintaining the general nature of an elongated flow. The resulting flows through the system have dimensions reflecting the initial reactant flow, although spreading can expand the flow and shielding gas and baffles can be used to limit spreading and/or further constrain the flow. Alternative nozzle designs for elongated nozzles are described in U.S. Pat. No. 6,919,054 to Gardner et al., entitled “Reactant Nozzles Within Flowing Reactors,” incorporated herein by reference. In alternative embodiments, a circular inlet can be used, which can be suitable for flame reactors and thermal reactors. Alternative configurations for high throughput laser pyrolysis, which can be adapted for in flight modification of the inorganic particles, are described in Published U.S. Patent Application 2005/020036 to Mosso et al., entitled “Particle Production Apparatus,” incorporated herein by reference.

Referring to FIG. 1, intense light delivery apparatus 122 generally can comprise an intense light source 164 and suitable optics, which are connected to light inlet conduit 132. A beam dump 166 can be connected to light outlet conduit 134 to terminate the light beam path. Laser pyrolysis can be performed with a variety of optical frequencies, using either a laser or other intense radiation source, such as a focused arc lamp. Some desirable light sources operate in the infrared portion of the electromagnetic spectrum, although other wavelengths can be used, such as the visible or ultraviolet regions of the spectrum. Excimer lasers can be used as intense ultraviolet light sources. CO₂ lasers are particularly convenient sources of light. Commercial CO₂ lasers are available in the watt to many kilowatts ranges. Suitable beam dumps/power meters are also commercially available. Light delivery apparatus 122 can further comprise suitable optical components, such as mirrors, lenses, widows and the like. In particular, the light inlet path from intense light source 164 into reaction chamber 120 can comprise a cylindrical lens that focuses the light in one dimension, generally the dimension along the flow of the reactants, such that in the beam is thinner in the dimension shown in FIG. 1 along the flow of reactants from the bottom of the page toward the top of the page. In the embodiment of FIG. 1 with a cylindrical lens, the beam would not be focused perpendicular to the plane of the page so that a thicker flow of reactants can pass through the light beam to increase throughput.

Reactant delivery portion 124 is configured to interface with reactant inlet 130 to deliver a flow of reactants into reaction chamber 120. Reactant delivery portion 124 can comprise suitable reservoirs, nozzles, injectors and the like to deliver gaseous reactants, vapor reactants, aerosol reactants or a combination thereof Many precursor compositions, such as metal/metalloid precursor compositions, can be delivered into the reaction chamber as a gas/vapor. Appropriate precursor compositions for gaseous delivery generally include compositions with reasonable vapor pressures, i.e., vapor pressures sufficient to get desired amounts of precursor gas/vapor into the reactant stream. The vessel holding liquid or solid precursor compositions can be heated (cooled) to increase (decrease) the vapor pressure of the precursor, if desired. Solid precursors generally are heated to produce a sufficient vapor pressure. In some embodiments, a carrier gas can be bubbled through a liquid precursor to facilitate delivery of a desired amount of precursor vapor. Similarly, a carrier gas can be passed over a solid precursor to facilitate delivery of the precursor vapor. Alternatively or additionally, a liquid precursor can be directed to a flash evaporator to supply a composition at a selected vapor pressure. The use of a flash evaporator to control the flow of non-gaseous precursors can provide a high level of control on the precursor delivery into the reaction chamber.

However, the use of exclusively gas/vapor phase reactants can be challenging with respect to the types of precursor compositions that can be used conveniently. Thus, techniques have been developed to introduce aerosols containing precursors, such as metal/metalloid precursors, into laser pyrolysis chambers. Improved aerosol delivery apparatuses for flowing reaction systems are described further in U.S. Pat. No. 6,193,936 to Gardner et al., entitled “Reactant Delivery Apparatuses,” incorporated herein by reference. In some embodiments, the aerosol is entrained in a gas flow, which can comprise an inert gas(es) and/or a gaseous reactant(s). Suitable aerosol generators generally include, for example, ultrasonic nozzle, an electrostatic spray system, a pressure-flow atomizer, an effervescent atomizer, a gas atomizer, a pressure flow atomizer, a spill-return atomizer, a gas-blast atomizer, a two fluid internal mix atomizer, a simplex atomizer, a two fluid external mix atomizer, a Venturi-based atomizer or combination thereof Ultrasonic nozzles with atomization surfaces and suitable broadband ultrasonic generators are available from Sono-Tek Corporation, Milton, N.Y., such as model 8700-120. Suitable gas atomizers are available from Spraying Systems, Wheaton, Ill.

For embodiments involving a plurality of metal/metalloid elements, the metal/metalloid elements can be delivered all as vapor, all as aerosol or as any combination thereof If a plurality of metal/metalloid elements is delivered as an aerosol, the precursors can be dissolved/dispersed within a single solvent/dispersant for delivery into the reactant flow as a single aerosol. Alternatively, the plurality of metal/metalloid elements can be delivered within a plurality of solutions/dispersions that are separately formed into an aerosol. The generation of a plurality of aerosols can be helpful if convenient precursors are not readily soluble/dispersible in a common solvent/dispersant. The plurality of aerosols can be introduced into a common gas flow for delivery into the reaction chamber through a common nozzle. Alternatively, a plurality of reactant inlets can be used for the separate delivery of aerosol and/or vapor reactants into the reaction chamber such that the reactants mix within the reaction chamber prior to entry into the reaction zone. Multiple reactant inlets for delivery into a laser pyrolysis chamber are described further in Published U.S. Patent Application 2002/0075126A to Reitz et al., entitled “Multiple Reactant Nozzle For A Flowing Reactor,” incorporated herein by reference.

In addition, for the production of highly pure materials, it may be desirable to use a combination of vapor and aerosol reactants. In some embodiments, vapor/gas reactants generally can be supplied at higher purity than is readily available at low cost for aerosol delivered compositions. At the same time, some elements, especially rare earth dopant(s)/additive(s), alkali metals and alkali earth metals as well as some transition metals, cannot be conveniently delivered in vapor form. Thus, in some embodiments, a majority of the material for the product compositions can be delivered in vapor/gas form while other elements are delivered in the form of an aerosol. The vapor and aerosol can be combined for reaction, for example, prior to introduction into the reaction chamber and/or following delivery through a single reactant inlet or a plurality of inlets into the reaction chamber.

Also, secondary reactants can be used in some embodiments to alter the oxidizing/reducing conditions within the reaction chamber and/or to contribute non-metal/metalloid elements or a portion thereof to the reaction products. The particles, in some embodiments, further comprise one or more non-(metal/metalloid) elements. For example, some compositions of interest are oxides, nitrides, carbides, sulfides or combinations thereof. For the formation of oxides, an oxygen source should also be present in the reactant stream, and other appropriate sources of non-(metal/metalloid) elements can be supplied to form the other compositions.

Suitable secondary reactants serving as an oxygen source for the formation of oxides include, for example, O₂, CO, N₂O, H₂O, CO₂, O₃ and the like and mixtures thereof Molecular oxygen can be supplied as air. In some embodiments, the metal/metalloid precursor compositions comprise oxygen such that all or a portion of the oxygen in product particles is contributed by the metal/metalloid precursors. Similarly, liquids used as a solvent/dispersant for aerosol delivery can similarly contribute secondary reactants, e.g., oxygen, to the reaction. In other words, if one or more metal/metalloid precursors comprise oxygen and/or if a solvent/dispersant comprises oxygen, a separate secondary reactant, e.g., a vapor reactant, may not be needed to supply oxygen for product particles. The conditions in the reactor should be sufficiently oxidizing to produce the metal/metalloid oxide particles.

Generally, a secondary reactant composition should not react significantly with the metal/metalloid precursor(s) prior to entering the radiation reaction zone since this can result in the formation of larger particles and/or damage the inlet nozzle. Similarly, if a plurality of metal/metalloid precursors is used, these precursors should not significantly react prior to entering the radiation reaction zone. If the reactants are spontaneously reactive, a metal/metalloid precursor and the secondary reactant and/or different metal/metalloid precursors can be delivered in separate reactant inlets or nozzles into the reaction chamber such that they are combined just prior to reaching the light beam.

Infrared absorber(s) for inclusion in the reactant stream include, for example, C₂H₄, isopropyl alcohol, NH₃, SF₆, SiH₄ and O₃. O₃ and isopropyl alcohol can act as both an infrared absorber and as an oxygen source. The radiation absorber(s), such as the infrared absorber(s), can absorb energy from the radiation beam and distribute the energy to the other reactants to drive the pyrolysis.

An inert shielding gas can be used to reduce the amount of reactant and product molecules contacting the reactant chamber components. Inert gases can also be introduced into the reactant stream as a carrier gas and/or as a reaction moderator. Appropriate inert gases generally include, for example, Ar, He, N₂ (for many reactions), other gases suitably inert for particular reactions, or combinations thereof.

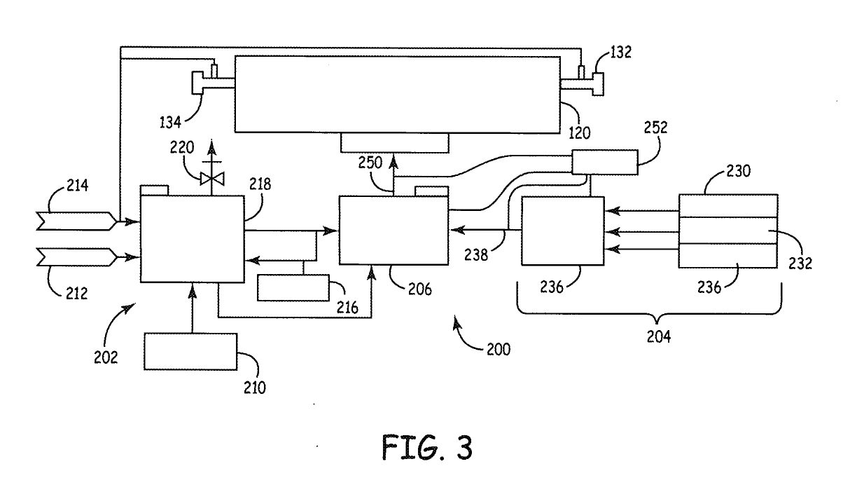

An embodiment of a reactant delivery section suitable for the delivery of vapor/gaseous reactants to reactant inlet 130 of FIG. 1 is shown schematically in FIG. 3. As shown in FIG. 3, reactant delivery apparatus 200 comprises a gas delivery subsystem 202 and a vapor delivery subsystem 204 that both join a mixing subsystem 206. Gas delivery subsystem 202 can comprise one or more gas sources, such as a gas cylinder or the like for the delivery of gases into the reaction chamber. As shown in FIG. 3, gas delivery subsystem 202 comprises reactant gas sources 210, 212, inert gas source 214, and an optional light absorbing gas source 231, which can supply a light absorbing gas for laser pyrolysis if a reaction precursor does not sufficiently absorb the intense light. In other embodiments, the gas delivery subsystem can comprise a different number of gas sources such that desired reactant gases and/or other gases can be selected as desired.

The gases combine in a gas manifold 218 where the gases can mix. Gas manifold can have a pressure relief valve 220 for safety. Inert gas source 214 can be also used to supply inert gas within tubular sections 132, 134 used to direct light into and from chamber 120. Mass flow controllers can be used to regulate the flow of gases to gas manifold 218.

Vapor delivery subsystem 204 comprises a plurality of flash evaporators 230, 232, 234. Although shown with three flash evaporators, vapor delivery subsystem can comprise, for example, one flash evaporator, two flash evaporators, four flash evaporators or more than four flash evaporators to provide a desired number of vapor precursors that can be selected for delivery into the reactor to form desired inorganic particles. Each flash evaporator can be connected to a liquid reservoir to supply liquid precursor in suitable quantities. Suitable flash evaporators are available from, for example, MKS Equipment or can be constructed from readily available components. The flash evaporators can be programmed to deliver a selected partial pressure of the particular precursor. The vapors from the flash evaporator are directed to a manifold 236 that directs the vapors to a common feed line 238. The vapor precursors mix within manifold 236 and common feed line 238. A flash evaporator can be replaced by a solid precursor delivery apparatus, which can heat a solid to generate a vapor that can then be delivered with a carrier gas if desired. The carrier gas can be, for example, an infrared absorber, a secondary reactant, an inert gas or mixtures thereof.

The gas compositions from gas delivery subsystem 202 and vapor compositions from vapor delivery subsystem 204 are combined within mixing subsystem 206. Mixing subsystem 206 can be a manifold that combines the flow from gas delivery subsystem 202 and vapor delivery subsystem 204. In the mixing subsystem 206, the inputs can be oriented to improve mixing of the combined flows of different vapors and gases at different pressures. The mixing block can have a slanted termination to reduce backflow into lower pressure sources. A conduit 250 leads from mixing subsystem 206 to reaction chamber 120.

Reactant delivery unit 200 can be configured to deliver a selected reactant composition based on a supply with a range of precursors and other reactants to tune a particular inorganic particle composition without refitting the unit since a number of precursors supplies can be integrated together within the unit simultaneously. For the formation of complex materials and/or doped materials, a significant number of reactant sources and, optionally, separate reactant ducts can be used for reactant/precursor delivery. For example, as many as 25 reactant sources and/or ducts are contemplated, although in principle, even larger numbers could be used.

Referring to FIG. 3, a heat controller 252 can be used to control the temperature of various components through conduction heaters or the like throughout the vapor delivery subsystem 204, mixing subsystem 206 and/or conduit 250 to reduce or eliminate any condensation of precursor vapors. A suitable heat controller is model CN132 from Omega Engineering (Stamford, Conn.). Overall precursor flow can be controlled/monitored by a DX5 controller from United Instruments (Westbury, N.Y.). The DX5 instrument can be interfaced with mass flow controllers (Mykrolis Corp., Billerica, Mass.) controlling the flow of one or more vapor/gas precursors. The automation of the unit can be integrated with a controller from Brooks-PRI Automation (Chelnsford, Mass.).

As noted above, the reactant stream can comprise one or more aerosols. The aerosols can be formed within the reaction chamber or outside of the reaction chamber prior to injection into the reaction chamber. If the aerosols are produced prior to injection into the reaction chamber, the aerosols can be introduced through reactant inlets comparable to those used for gaseous/vapor reactants. For the formation of inorganic particles with complex compositions, additional aerosol generators and/or vapor/gas sources can be combined to supply the desired precursor compositions within the reactant stream.

Using aerosol delivery apparatuses, solid precursor compositions can be delivered by dissolving the compositions in a solvent. Alternatively, powdered precursor compositions can be dispersed in a liquid/solvent for aerosol delivery. Liquid precursor compositions can be delivered as an aerosol from a neat liquid, a multiple liquid dispersion or a liquid solution. Aerosol reactants can be used to obtain a significant reactant throughput. A solvent/dispersant can be selected to achieve desired properties of the resulting solution/dispersion. Suitable solvents/dispersants include water, methanol, ethanol, isopropyl alcohol, other organic solvents, metal/metalloid precursors themselves and mixtures thereof. The solvent should have a desired level of purity such that the resulting particles have a desired purity level. Some solvents, such as isopropyl alcohol, are significant absorbers of infrared light from a CO₂ laser such that no additional light absorbing composition may be needed within the reactant stream if a CO₂ laser is used as a light source.

The precursor compositions for aerosol delivery are dissolved in a solution generally with a concentration in the range(s) greater than about 0.1 molar. Generally, increasing the concentration of precursor in the solution increases the throughput of reactant through the reaction chamber. As the concentration increases, however, the solution can become more viscous such that the aerosol may have droplets with larger sizes than desired. Heating the solution can increase solubility and lower the viscosity to increase production rate without increasing aerosol droplet size. Thus, selection of solution concentration can involve a balance of factors in the selection of a suitable solution concentration.

If precursors are delivered as an aerosol with a solvent present, the solvent generally can be rapidly evaporated by the radiation (e.g., light) beam in the reaction chamber such that a gas phase reaction can take place. In addition, solvent generally can also evaporate prior to reaching the light beam during delivery. Under appropriate conditions, the resulting particles may not be highly porous, in contrast to other approaches based on aerosols in which the solvent cannot be driven off rapidly. Thus, the fundamental features of the laser pyrolysis reaction can be essentially unchanged by the presence of an aerosol. Nevertheless, the reaction conditions are affected by the presence of the aerosol. The use of aerosol reactants for laser pyrolysis particle production is described further in U.S. Pat. No. 6,849,334 to Home et al., entitled “Optical Materials And Optical Devices,” incorporated herein by reference.

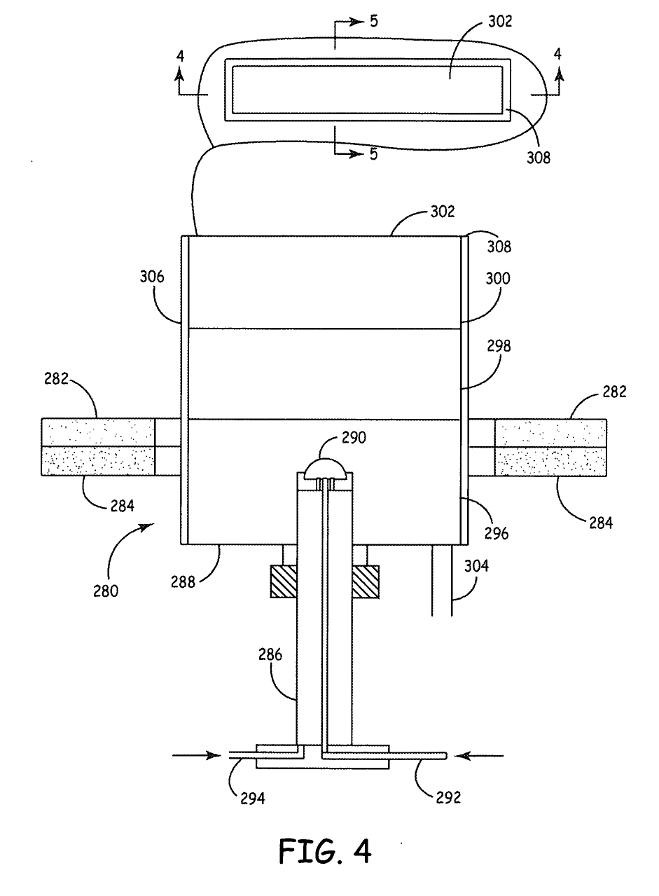

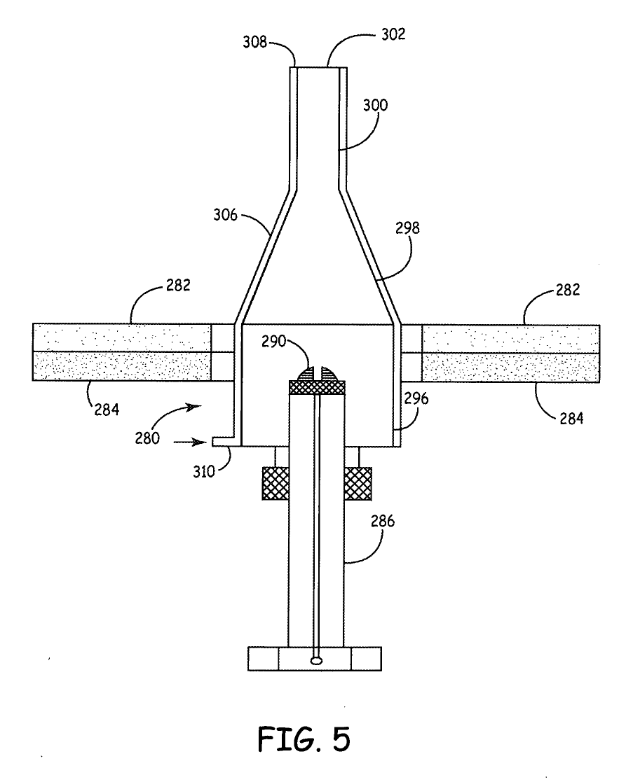

An embodiment of a reactant delivery nozzle configured to deliver an aerosol reactant along with gas/vapor is shown in FIGS. 4 and 5. Inlet nozzle 280 connects with a reaction chamber at its lower surface 282. Inlet nozzle 280 comprises a plate 284 that bolts into lower surface 282 to secure inlet nozzle 280 to the reaction chamber. Inlet nozzle 280 comprises an inner nozzle 286 and an outer nozzle 288. Inner nozzle 286 can have, for example, a twin orifice internal mix atomizer 290 at the top of the nozzle. Suitable gas atomizers are available from Spraying Systems, Wheaton, Ill. The twin orifice internal mix atomizer 290 has a fan shape to produce a thin sheet of aerosol and gaseous compositions. Liquid is fed to the atomizer through tube 292, and gases for introduction into the reaction chamber are fed to the atomizer through tube 294. Interaction of the gas with the liquid assists with droplet formation.

Outer nozzle 288 comprises a chamber section 296, a funnel section 298 and a delivery section 300. Chamber section 296 holds the atomizer of inner nozzle 286. Funnel section 298 directs the aerosol and gaseous compositions into delivery section 300. Delivery section 300 leads to a rectangular reactant opening 302, shown in the insert of FIG. 4. Reactant opening 302 forms a reactant inlet into a reaction chamber for laser pyrolysis. Outer nozzle 288 comprises a drain 304 to remove any liquid that collects in the outer nozzle. Outer nozzle 288 is covered by an outer wall 306 that forms a shielding gas opening 308 surrounding reactant opening 302. Inert shielding gas is introduced through tube 310. Additional embodiments for the introduction of an aerosol with one or more aerosol generators into an elongated reaction chamber is described in U.S. Pat. No. 6,193,936 to Gardner et al., entitled “Reactant Delivery Apparatuses,” incorporated herein by reference.

Referring to FIG. 1, particle modification section 126 can comprise one or more modification elements 140, each of which can be an inlet or a radiation source. Inlets can be operably connected to an appropriate composition supply system. An inlet can be oriented to deliver the composition, such as an inert gas or surface modifying composition, with a desired momentum to the flow with product inorganic particles. More specifically, the composition can be delivered to mix quickly and completely with the particles without disrupting the flow. Suitable inlets are described further below.

Referring to FIG. 1, flow section 104 connects the laser pyrolysis apparatus 102 with the collector system 106 and comprises a conduit or the like. In some embodiments, the flow section is a conduit directing the flow to a collector. If flow section 104 does not comprise any modification elements, all particle modification is initiated with the reaction chamber, e.g., the laser pyrolysis chamber. The flow section 104 then conveys the particles from the reaction chamber to the collector system without further manipulation of the particle properties. However, in other embodiments, flow section 104 comprises one or more modification elements.

In particular, in some embodiments, referring to FIG. 1, flow section 104 comprises one or more modification elements 320 each involved with the delivery of a composition or interaction with radiation from a radiation source. Each inlet generally is in fluid communication a composition supply element having a reservoir to deliver a vapor and/or aerosol comprising the desired composition. Suitable radiation sources are described above in detail below. Flow section 104 can be distinguished from the laser pyrolysis apparatus 102 due to a change in direction of the flow or due to a change in cross sectional area available to the flow, such as a constriction. In some embodiments, there may not be a clear boundary between the laser pyrolysis apparatus 102 and flow section 104, and the boundary can be selected conceptually as convenient. A conduit of the flow section can be straight, or it can be curved to redirect the flow as appropriate to reach the collection system. In addition, the cross sectional dimensions may or may not remain relatively constant between the inorganic particle synthesis reactor and the flow/modification section, and the conduit can have a circular cross section over a portion of its length even if the reaction chamber flow is elongated.

While FIG. 1 shows a flow section with 2 modification elements, flow sections can be configured with 1, 2, 3, 4, 5, 7, 8, 9, 10 or more modification elements. The number of modification elements, their relative positioning and the configuration of individual modification elements can be designed to achieve desired product particle properties. In general, the length along the flow of the flow/coating system can be selected to provide desired space for placement of desired modification elements. Factors for consideration in selecting the order and positioning of the modification elements for placement within the reaction chamber generally are similarly relevant for evaluating the order and placement within the flow section.

In addition, FIG. 1 shows flow section 104 having a conduit with roughly constant cross section perpendicular to the flow along the conduit, although conduit of flow section 104 changes direction. However, a flow section can change cross section perpendicular to the flow, as described further below. Tapering of the conduit can increase the density within the flow, which can result in some controlled agglomeration of the particles within the flow. If desired, the flow can be controlled to effectively form a fluidized bed reactor within the flow to result in further controlled agglomeration prior to collection of the particles. Directing the flow to a fluidized bed reactor is described further in copending and U.S. patent application Ser. No. 11/438,468 filed on May 22, 2006 to Chiruvolu et al., entitled “NanoStructured Composite Particles and Corresponding Processes,” incorporated herein by reference.

Referring to FIG. 1, collection system 106 can comprise a collector 330, a negative pressure device 332 and a scrubber 334 with appropriate conduits connecting the flow between these components. Collector 330 can be, for example, a filter, a bag collector, an electrostatic collector or the like. Suitable filters include, for example, flat filters or cylindrical filters. In some embodiments, the collector can be a bag collector for continuous collection without disrupting particle production, such as describe in U.S. Pat. No. 5,874,684 to Parker et al., entitled “Nanocrystalline Materials,” and U.S. Pat. No. 6,270,732 to Gardner et al., entitled Particle Collection Apparatus And Associated Methods, both of which are incorporated herein by reference. Suitable negative pressure devices include, for example, pumps, blowers, an aspirator/venturi, compressor, ejector or the like. Vacuum pumps are commercially available, such as available from Leybold Vacuum Products, Export, Pa. or a dry rotary pump from Edwards, such as model QDP80. Optional scrubber 334 can be used to remove environmentally harmful compounds from the filtered flow to reduce their release into the atmosphere. Suitable scrubbers include, for example, in-line Sodasorb® (W. R. Grace) chlorine traps.

The pressure in the reaction chamber generally can be measured with a pressure gauge. For example, a manometer can be used as a pressure gauge. Manometers provide accurate linear responses with respect to pressure. In some embodiments, the pressure gauge is connected to a controller. The controller can be used to monitor the pressure in reaction chamber and maintain the pressure in reaction chamber within a specified range using a feedback loop with the collection system. The operation of the feedback loop depends on the structural design of the collection system, and may involve, for example, the adjustment of a valve, pumping speed and/or filter pulsing rates, with automatic adjustment by the controller. Suitable automatic valves for interfacing with the controller are available from Edwards Vacuum Products, Wilmington, Mass. If manual values are used, the controller can notify an operator to adjust the manual valve appropriately.

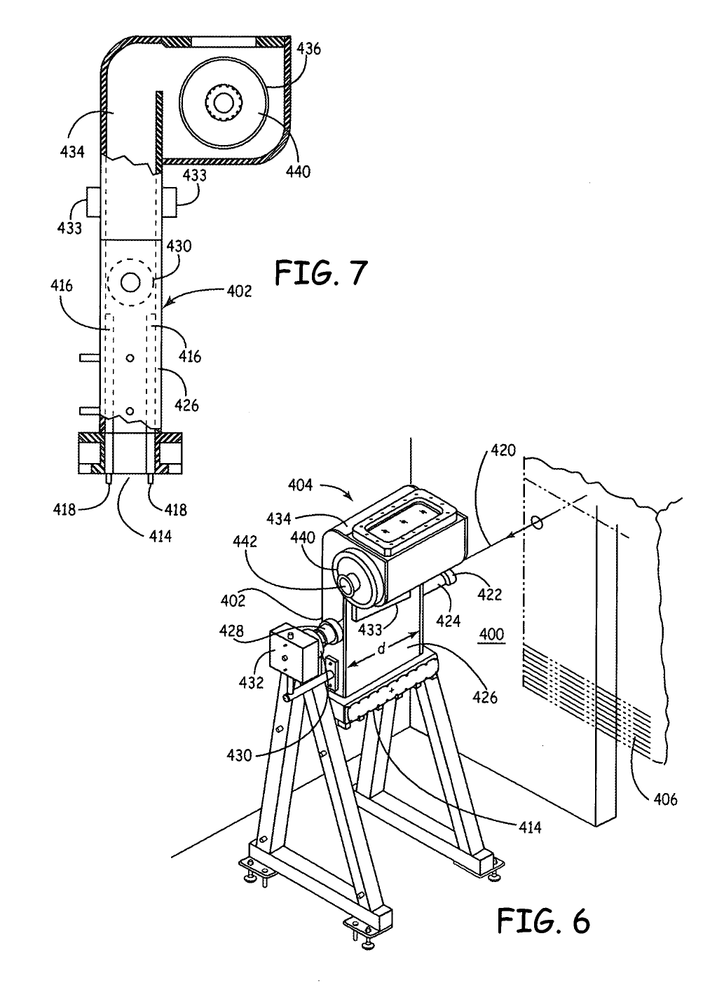

An embodiment of an inorganic particle production system is shown in FIGS. 6 and 7 in which there is no clear transition between the reaction chamber and a flow section. Thus, the flow of the product particles is not disrupted in any way by the transition into a flow section until the flow transitions into the collector. One can arbitrarily demarcate a transition point between the reaction chamber with the reaction zone and a flow region with a modification element.

Referring to FIGS. 6 and 7, a pyrolysis reaction system 400 includes reaction chamber 402, a particle collection system 404 and laser 406. Reaction chamber 402 includes reactant inlet 414 at the bottom of reaction chamber 402 where reactant delivery system 408 connects with reaction chamber 402. In this embodiment, the reactants are delivered from the bottom of the reaction chamber while the products are collected from the top of the reaction chamber, although in alternative embodiments, this configuration of flow can be reversed. Shielding gas conduits 416 are located on the front and back of reactant inlet 414. Inert gas is directed into shielding gas conduits through ports 418. The shielding gas conduits direct shielding gas along the inside walls of reaction chamber 402 to inhibit association of reactant gases or products with the walls.

Reaction chamber 402 is elongated along one dimension denoted in FIG. 6 by “d”. A laser beam path 420 enters the reaction chamber through a window 422 displaced along a tube 424 from the main chamber 426 and traverses the elongated direction of reaction chamber 402. The laser beam passes through tube 428 and exits window 430. In one embodiment, tubes 424 and 428 displace windows 422 and 430 about 11 inches from the main chamber. The laser beam terminates at beam dump 432. In operation, the laser beam intersects a reactant stream generated through reactant inlet 414. A modification element 433 is located along main chamber 426 upstream from the reaction zone.

The top of main chamber 426 opens into particle collection system 404. Particle collection system 404 includes outlet duct 434 connected to the top of main chamber 426 to receive the flow from main chamber 426. Outlet duct 434 carries the product particles out of the plane of the reactant stream to a cylindrical filter 436. Filter 436 has a seal on one end, and the other end of filter 436 is fastened to disc 440. A vent is secured to the center of disc 440 to provide access to the center of filter 436. In use, the vent is attached by way of ducts to a pump or the like. Thus, product particles are trapped on filter 436 by the flow from the reaction chamber 402 to the pump.

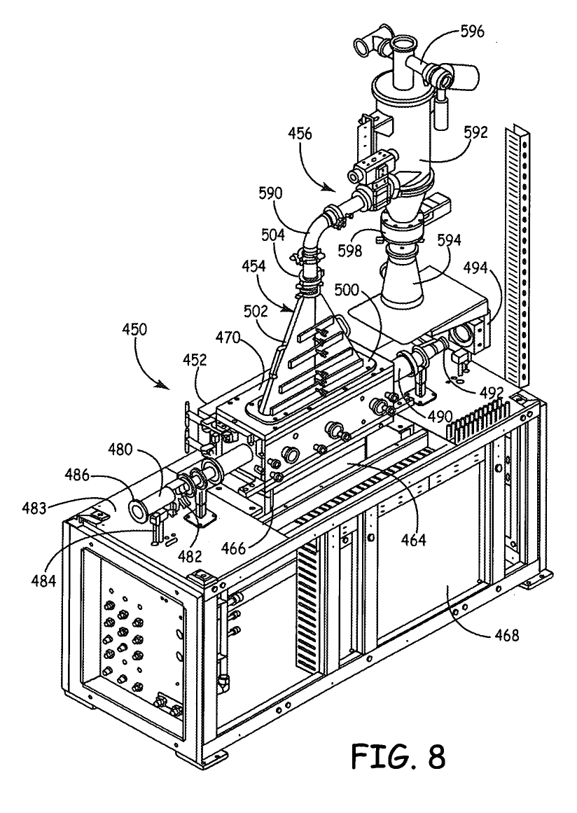

An alternative embodiment of an inorganic particle production system is shown in FIG. 8 with a flow section having a taper along one dimension. Referring to FIG. 8, a pyrolysis reaction system 450 includes reaction chamber 452, particle transfer element 454, and a particle collection system 456. Reaction chamber 452 interfaces with inlet nozzle 464 at a bottom surface 466 of reaction chamber 452 where reactant delivery system 468 connects with reaction chamber 452. Particle transfer element 454 connects along a top surface 470 with reaction chamber 452. In this embodiment, the reactants are delivered from the bottom of the reaction chamber while the products are collected from the top of the reaction chamber. Inlet nozzle 464 has a central reactant channel with shielding gas conduits adjacent the front and back of the central reactant channel similar to the configuration shown in FIG. 2.

First light tube 480 is configured to direct a light beam path through the reaction chamber along the elongated length of the chamber. First light tube 480 comprises a cylindrical lens 482 oriented to focus along the direction oriented along a normal between the top surface 470 to the bottom surface 466 of reaction chamber 452 while not focusing the light along the direction parallel to table top 483. Inert gas is directed into first tube 482 from gas tubing 484 to keep the optical path clean. First light tube 480 connects directly or indirectly with a light source at flange 486. The light beam path continues through reaction chamber 450 to second light tube 490. Second light tube 490 terminated with a window 492 that directs the beam to a light meter/beam dump 494. In operation, the light beam, generally from a CO₂ laser, intersects a reactant stream generated from inlet nozzle 464.

A sectional view of particle transfer element 454 is shown in FIG. 9 along with top plate 496 of reaction chamber 452 that forms top surface 470. Portions of support structures are not shown in the figure to facilitate viewing of the apparatus. Particle transfer element 454 comprises attachment plate 500, flow conduit 502 and cooling collar 504. Attachment plate 500 provides for secure fastening of particle transfer element 454 to top plate 496.

In this embodiment, flow conduit 502 comprises an interior flow channel 508 and four symmetric mixing stations 510, 512, 514, 516 at different selected heights along flow conduit 502. Each mixing station comprises two symmetrically positioned gas inlet ports 520. Mixing station 510 has symmetric compartments 522, 524, mixing station 512 has symmetric compartments 526, 528, mixing station 514 has symmetric compartments 530, 532 and mixing station 516 has symmetric compartments 534, 536. Each compartment 522-536 is fluidly connected to a gas port 520. Also, each compartment 522-536 is connected to a plurality of jets 540 that fluidly connect each compartment with interior flow channel 508, in which a portion of jets 540 are displayed in FIG. 9.

In use, gas delivered through ports 520 pressurizes compartments 522-536 behind the restricted flow through jets 540. The pressurized delivery of gas through jets 540 provides a desired level of good mixing within the flow, as described further below. Flow conduit 502 further comprises sampling ports 542 through which product particles in the flow can be removed for examination at particular locations along the flow.

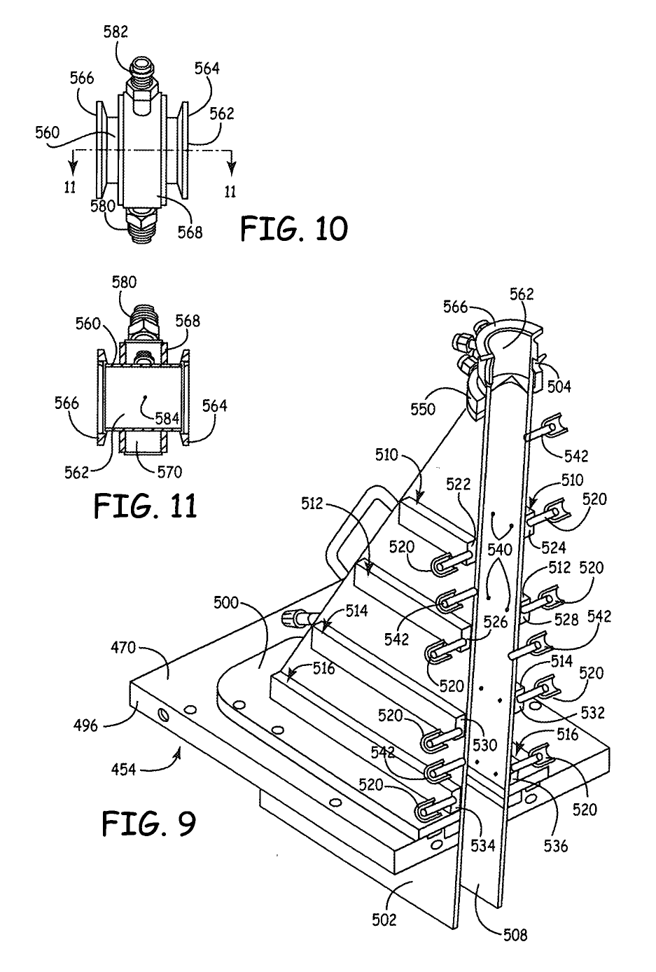

Cooling collar 504 is secured with a gas tight seal to flow conduit 502 with a fastening band 550, although, in other embodiments, flow collar 504 can be welded or otherwise fastened to form a gas tight seal. FIGS. 10 and 11 display cooling collar 504 separate form flow conduit 502. Cooling collar 504 comprises a cylindrical element 560 with a central channel 562 that provides for flow between flow conduit 502 and collection system 456. Attachment flanges 564, 566 extend from cylindrical element 560 and provide to attachment of cooling collar into the apparatus. Gas chamber structure 568 is attached around the center of cylindrical element 560 to form a gas tight cavity 570 connected to two symmetrically positioned gas ports 580, 582, which have appropriate fittings, such as swage-lock fittings, to connect with a gas line. Cylindrical element 560 has two gas jets 584 (only one is shown) that are fluidly connected to the interior of cavity 570 such that pressurized gas delivered into cavity 570 can be delivered into central channel 562 through jets 584.

Central channel 562 of cooling collar 504 leads into particle collection system 404. Particle collection system 404 comprises flow tube 590, collection chamber 592 and container 594. Flow tube 590 provides a fluid connection between cooling collar 504 and collection chamber 592. Collection chamber 592 is a single bag collector which uses a flexible bag to separate a product plenum from a clean plenum. Back pulse system 596 provides occasional back pulses of gas to removed product powders from the bag membrane so that the powders fall to the bottom of collection chamber 592. The bottom of collection chamber 594 is connected with valve 598 that is releasably connected to container 594. When valve 598 is open powder can fall into container 594. To remove and replace container 594, valve 598 can be closed. Collection chamber 594 also leads to a vent 600 that generally is connected to a scrubber and a pump. Other collection systems can be used in place of the single bag collector if desired.

Modification elements that deliver a fluid composition, such as a gaseous composition, into the flow have been described generally above with respect to the embodiments in FIGS. 1-11. In general, the modification elements can incorporate small area inlets to direct a high momentum flow to mix with the product flow from the light reaction zone. The high momentum flow provides very rapid mixing for superior performance with respect to the objectives of the mixing. Rapid speed of mixing is generally desirable since the processes in the product flow being influenced themselves may take place in a rapid time frame. It generally is also desirable for the mixing to yield uniform properties across the flow in a very short time frame so that the product particles are correspondingly very uniform upon collection.

The introduction of cooling gas to thermally modify a reaction from a tube, thermal reactor is described in Published U.S. Patent application 2006/0024435 to Holunga et al., entitled “Turbulent Mixing Aerosol Nanoparticle Reactor and Method of Operating the Same,” incorporated herein by reference. In contrast, reactions in laser pyrolysis reactor quench very rapidly, but even in laser pyrolysis reactors the thermal modification of the flow can provide very significant influences in the nature of the product particle properties. In addition, the nature of the particular reaction influences the thermal condition of the product flow so that the thermal conditioning can be influenced by the reaction and the desired product properties. Furthermore, laser pyrolysis apparatuses for high production rates may not have cylindrically symmetric flow conduits, so that new configurations are needed to adapt the mixing inlets according to the flow geometry.

To achieve a high momentum for the mixing composition relative to the product flow, the area of the inlet(s) associated with a particular modification element generally can be no more than about 0.15 times the cross sectional area of the product flow conduit, in other embodiments no more than about 0.1 times and in further embodiments no more than about 0.02 times the cross sectional are of the product flow conduit. A person of ordinary skill in the art will recognize that additional ranges of cross sectional area of the inlet(s) are contemplated and are within the scope of the present disclosure. Also, it is desirable for the mixing composition to not significantly alter the flow properties through the light reaction zone. The downstream affect on the flow properties can be influenced by the volume of mixing flow and the position of the modification element. As the modification element is drawn closer to the light reaction zone it may be particularly desirable to reduce the amount of flow from the mixing inlets with significant momentum downstream. The reduction of downstream momentum can be achieved through the collimation of an orthogonal flow and/or by angling the inlet slightly upstream. In some embodiments, a well collimated stream of additive composition spreads by no more than a factor of ten and in further embodiments no more than a factor of five in cross sectional area a distance of 10 centimeters from the inlet if the flow does not interact with another flow or structure.

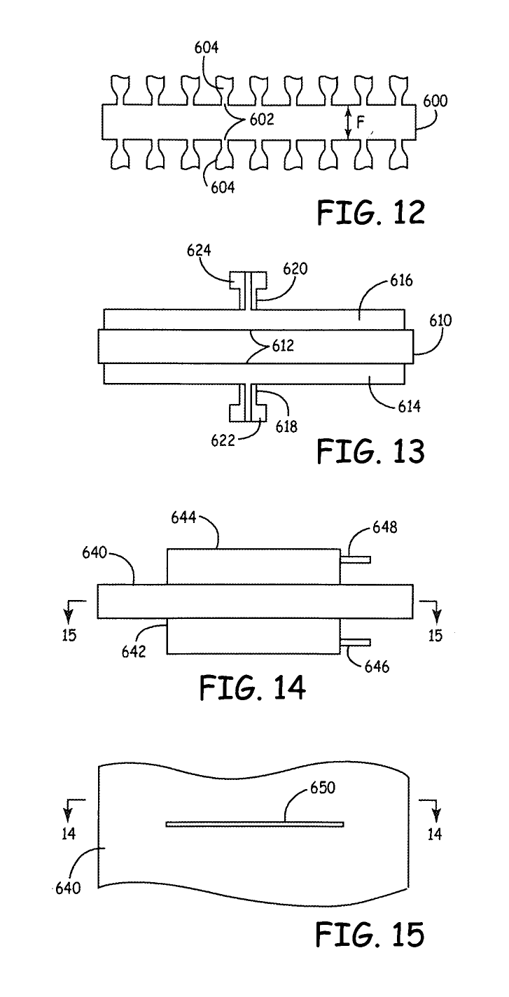

The modification element generally comprises one or more inlets configured to direct modifying fluid into a flow channel with product inorganic particles. In general it is desirable to include two or more inlets, which can be placed in pairs on opposite elongated sides of the flow conduit as shown below with respect to FIGS. 12-15. The inlets may or may not be placed directly opposite each other on the opposite sides of the flow channel. Suitable inlets include, for example, thin knife slits, nozzle jets and the like have a desired small area.

Thin knife slits can be designed to generate a very well collimated flow orthogonal to the product flow or slightly angled upstream. Commercially available units, such as a Super Air Knife™ from EXAIR Corp., Cincinnati, Ohio, can be incorporated into the flow system, or units can be appropriately constructed. In some embodiments, the knife slits can have a gap no more than 0.025 inches, in other embodiments no more than 0.010 inches and in further embodiments from about 0.0002 to 0.005 inches. To obtain relatively uniform mixing, the knife slits can extend around at least about 10 percent of the circumference of the product conduit and in other embodiments, at least about 20 percent of the circumference of the product conduit. A person or ordinary skill in the art will recognize that additional ranges of slit gaps and coverage of the conduit circumference within the explicit ranges above are contemplated and are within the scope of the present disclosure.

In further embodiments, the modification inlets are high velocity jets. With high velocity fluid jets to inject the additive fluid into the relatively low velocity product flow to accomplish mixing on a timescale that is fast compared with diffusional or turbulent eddy mixing. The rapid mixing can be important to achieve more uniform product particles as well as to accomplish the particle modification more quickly, which corresponds with modification within a smaller section of the flow channel. The fast stream adds energy to the mixed flow as well as diluted the flow such that particle agglomeration is reduced after the mixing with the additive fluid.

The modification element is generally configured to interface with flow conduit with an elongated, i.e., non-circular and non-square, cross section. The jets can be configured to yield roughly equal mixing along the elongated dimension of the flow channel cross section such that the resulting powder of product particles are more uniform. This configuration of the jets involves the selection of the number of jets, which then generally can be positioned with approximately equal spacing on each side of the flow channel. Criteria to select the number of jets and the size of the jets are described below. In general, the jets can comprise a nozzle that generates a well collimated jet of fluid or a pin hole that generates a spray.

Two embodiments of modification elements are shown in sectional views in FIGS. 12 and 13. Referring to FIG. 12, flow conduit 600 interfaces with a modification element comprising nine jets 602 on each elongated side of the conduit. Each jet 602 is formed by a pin hole through the wall of the flow conduit. A fluid supply conduit 604 is connected to each jet 602. Generally, the pressure in each fluid supply conduit is selected to be about equal to each other to provide consistent mixing.

An alternative embodiment is shown in FIG. 13. Referring to FIG. 13, flow conduit 610 interfaces with a modification element also comprising nine jets 612 along each elongated side of flow conduit 610. Fluid delivery manifolds 614, 616 are associated with the jets on the respective sides of the flow conduit. Fluid is supplied to delivery manifolds 614, 616, respectively, through fluid inlets 618, 620, which connect with a fluid supply tube or the like at fittings 622, 624.

Parameters to determine strong mixing conditions with jets into a flow channel with a circular cross section are described in Published U.S. Patent Application 2006/0024435A to Holunga et al., entitled “Turbulent Mixing Aerosol NanoParticle Reactor and Method of Operating Same,” incorporated herein by reference (the '435 application). Referring to FIG. 12, the smaller dimension of the flow channel cross section, marked as “t” in the figure can be used as a rough replacement for the diameter in the calculations in the '435 application. Then, rough estimates can be made for suitable flows and diameters for the jets that provide desired strong mixing. We can estimate then the spacing between adjacent jets to be between 0.5 and 1.5 of the small channel dimension “t”.

For the flow channels described herein that do not have circular cross sections, other inlet shapes besides jets can adapt the concepts of high momentum inlets to generate strong mixing conditions in the product flow. As noted above, knife slits can be conveniently used to provide for good mixing conditions with a well collimated flow. One embodiment is shown in FIGS. 14 and 15. Referring to FIGS. 14 and 15, flow conduit 640 has two knife slit systems 642 and 644 mounted on respective sides of the flow conduit. Each knife slit system 642, 644 has a tubular connection 646, 648, respectively, to deliver mixing composition to the knife slit system. Knife slit systems 642, 644 can be configured to deliver a well collimated flow across the cross section of flow conduit 640 through very narrow slits 650.

The composition mixed with the flow at the modification element can be an inert gas that is used to manipulate the thermal conditions in the flow. In general, the composition can be any fluid, which can comprise, for example, gas, vapor, neat liquid, liquid dispersions, liquid blends, aerosol, and combinations thereof. In general, suitable inert gases can be selected based on the particular composition of the flow. Some examples of generally acceptable inert gases are described above. To control the thermal properties, the inert gas can be injected at a desired temperature, which can involve heating above room temperature or cooling below room temperature. Suitable temperature control apparatus can be incorporated into the apparatus that supplied fluid to the modification element, and thermal control elements may or may not be built into the modification element itself.

In some embodiments, the modification element is configured to deliver through the mixing inlet(s) compositions that modify the surface properties of the particles. For example, the compositions can comprise water to contribute —OH groups to the particle surfaces, HX, where X is a halogen to contribute a halogen along the particle surface, a scavenger to react with elements from the flow to make them unavailable to modify surface chemistry that encourage bridging bonds that distort the particle surfaces, or other suitable surface modifying compositions. The surface modifying compound can diluted with an inert gas for delivery to achieve the desired mixing. Oxygen can be added to complete oxidation, hydrogen may be added to passivate surfaces, or other reagents can be added that provide a surface termination that may later facilitate dispersion techniques.

As noted above, some modification sections can comprise radiation sources. Suitable radiation sources include, for example, an electron beam, a corona discharge or a source of electromagnetic radiation. Klystrons or other electron beam sources can be adapted for these applications. Suitable electromagnetic radiation can be used, such as infrared, visible, microwave, ultraviolet, x-rays and combinations thereof. Suitable light sources can be used to deliver desired wavelengths, such as ultraviolet light emitting diodes, as described in U.S. Pat. No. 6,734,033 to Emerson et al., entitled “Ultraviolet Light Emitting Diode,” incorporated herein by reference; a wide range of diodes and other light sources in the visible; infrared diodes, as described in U.S. Pat. No. 6,783,260 to Machi et al., entitled “IR Laser Based High Intensity Light,” incorporated herein by reference; and microwaves, as described in Published U.S. Patent Application 2004-0245932A to Durand, entitled “Microwave Generator With Virtual Cathode,” incorporated herein by reference.

### Inorganic Particle Properties

In embodiments of particular interest, the inorganic particles have an average diameter of no more than about one micron. A collection of submicron/nanoscale particles may have an average diameter for the primary particles of no more than about 500 nm, in some embodiments no more than about 250 nm, in further embodiments from about 2 nm to about 100 nm, alternatively from about 2 nm to about 75 nm, or from about 2 nm to about 50 nm. A person of ordinary skill in the art will recognize that other ranges within these specific ranges are contemplated and are within the present disclosure. Particle diameters are evaluated by transmission electron microscopy. For non-spherical particles, diameter measurements on particles are based on an average of length measurements along the principle axes of the particle.

The primary particles can have a roughly spherical gross appearance, or they can have rod shapes, plate shapes or other non-spherical shapes. Upon closer examination, crystalline particles may have facets corresponding to the underlying crystal lattice. Amorphous particles generally can have a spherical aspect. In some embodiments, the particles can have average aspect ratios of the longest length along a principle axis to the shortest distance along a principle axis of the particle is no more than about 2 and in further embodiments no more than about 1.5. A person of ordinary skill in the art will recognize that additional ranges of aspect ratios within the explicit ranges are contemplated and are within the present disclosure.

The particles generally have a surface area corresponding to particles on a submicron scale as observed in the micrographs. Furthermore, the particles can manifest unique properties due to their small size and large surface area per mass of material. For example, by UV-visible spectroscopy, the absorption spectrum of crystalline, nanoscale TiO₂ particles is shifted relative to the absorption spectrum of bulk TiO₂ particles.

The primary particles can have a high degree of uniformity in size. Laser pyrolysis generally results in particles having a very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. As determined from examination of transmission electron micrographs, the primary particles generally have a distribution in sizes such that at least about 95 percent, and in other embodiments at least about 99 percent, of the primary particles have a diameter at least about 40 percent of the average diameter and no more than about 160 percent of the average diameter. In further embodiments, the primary particles have a distribution of diameters such that at least about 95 percent, and in other embodiments at least about 99 percent, of the primary particles have a diameter at least about 60 percent of the average diameter and no more than about 140 percent of the average diameter. A person of ordinary skill in the art will recognize that other ranges within these specific ranges are contemplated and are covered by the disclosure herein.

Furthermore, in preferred embodiments no primary particles have an average diameter greater than about 5 times the average diameter, in other embodiments no more than about 4 times the average diameter, in further embodiments no more than about 3 times the average diameter, and in additional embodiments no more than about 2 times the average diameter. In other words, the particle size distribution effectively does not have a tail indicative of a small number of particles with significantly larger sizes. This is a result of the small reaction region and corresponding rapid quench of the particles. An effective cut off in the tail of the size distribution indicates that there are less than about 1 particle in 10⁶ have a diameter greater than a specified cut off value above the average diameter. High particle uniformity can be exploited in a variety of applications. In particular, high particle uniformity can lead to well controlled properties, such as optical properties.

As used herein, primary particles and primary particle size refer to particles and their size, that do not display any visible necking on a transmission electron micrograph. Such particles are in principle dispersible under appropriate conditions. However, it may not be possible to ideally disperse the particles completely even if there is no visible necking that is hard-fusing the particles. Since techniques do not provide for observing the individual particles in dispersions the details of the dispersion process are necessarily somewhat incompletely understood. However, the size of the dispersed particles, as measured by dynamic light scattering measurements, may approach the size observed in TEM micrographs and/or BET surface area characterization.

Secondary particle size refers to the size of dispersed particles in a fluid. The secondary particle sizes can be measured with techniques such as light scattering and the like. Commercial instruments can be used to measure the particle sizes in dispersions. In general, the secondary particle size can be the same order of magnitude as the primary particle size. In some embodiments, the average secondary particle size can be less than a factor of five times the average primary particle size and in further embodiments no more than a factor of three larger than the average primary particle size. Furthermore, the techniques described herein, such as engineering the particle surface chemistry, reducing agglomeration in the flow and/or cooling the particles prior to collection, can further improve the dispersiblity of the particles even more than the generally very good dispersibility of particles formed by laser pyrolysis.

In addition to the uniformity of the inorganic particles, the inorganic particles may have a very high purity level. Furthermore, crystalline inorganic particles, such as those produced by laser pyrolysis, can have a high degree of crystallinity. The techniques described herein can be used to form highly crystalline submicron particles for a broader range of crystal structures than were available using earlier laser pyrolysis techniques. The degree of crystallinity can be evaluated by comparing integrated peak intensities for an x-ray diffractogram with comparable values for a standard diffractogram for the conventional bulk crystalline material. In addition, impurities on the surface of the particles may be removed by heating the particles, which can be performed in-flight, to achieve not only high crystalline purity but high purity overall.

A variety of inorganic particle compositions can be produced by laser pyrolysis. Specifically, the compositions can include one or more metal/metalloid elements forming a crystalline or amorphous material with an optional dopant or additive composition. In addition, dopant(s)/additive(s) can be used to alter the optical, chemical and/or physical properties of the particles. In general, the submicron/nanoscale inorganic particles can generally be characterized as comprising a composition comprising a number of different elements and present in varying relative proportions, where the number and the relative proportions can be selected as a function of the application for the particles. Typical numbers of different elements include, for example, numbers in the range(s) from about 2 elements to about 15 elements, with numbers of 1, 2, 3, 4, 5, 6, 7, 8, 9, 10, 11, 12, 13, 14, and 15 being contemplated, in which some or all of the elements can be metal/metalloid element. General numbers of relative proportions include, for example, ratio values in the range(s) from about 1 to about 1,000,000, with numbers of about 1, 10, 100, 1000, 10000, 100000, 1000000, and suitable sums thereof being contemplated. In addition, elemental materials are contemplated in which the element is in its elemental, un-ionized form, such as a metal/metalloid element, i.e., M⁰.

Alternatively or additionally, such submicron/nanoscale particles can be characterized as having the following formula:

AₐB_{b}C_{c}D_{d}EₑF_{f}G_{g}HₕIᵢJⱼKₖLₗMₘNₙOₒ,

where each A, B, C, D, E, F, G, H, I, J, K, L, M, N, and O is independently present or absent and at least one of A, B, C, D, E, F, G, H, I, J, K, L, M, N, and O is present and is independently selected from the group consisting of elements of the periodic table of elements comprising Group 1A elements, Group 2A elements, Group 3B elements (including the lanthanide family of elements and the actinide family of elements), Group 4B elements, Group 5B elements, Group 6B elements, Group 7B elements, Group 8B elements, Group 1B elements, Group 2B elements, Group 3A elements, Group 4A elements, Group 5A elements, Group 6A elements, and Group 7A elements; and each a, b, c, d, e, f, g, h, i, j, k, l, m, n, and o is independently selected and stoichiometrically feasible from a value in the range(s) from about 1 to about 1,000,000, with numbers of about 1, 10, 100, 1000, 10000, 100000, 1000000, and suitable sums thereof being contemplated. In other words, the elements can be any element from the periodic table other than the noble gases. Elements from the groups Ib, IIb, IIIb, IVb, Vb, VIb, VIIb and VIIIb are referred to as transition metals. In addition to the alkali metals of group I, the alkali earth metals of group II and the transition metals, other metals include, for example, aluminum, gallium, indium, thallium, germanium, tin, lead, bismuth and polonium. The non-metal/metalloid elements include hydrogen, the noble gases, carbon, nitrogen, oxygen, fluorine, sulfur, chlorine, selenium, bromine, and iodine. As described herein, all inorganic compositions are contemplated, as well as all subsets of inorganic compounds as distinct inventive groupings, such as all inorganic compounds or combinations thereof except for any particular composition, group of compositions, genus, subgenus, alone or together and the like.

While some compositions are described with respect to particular stoichiometries/compositions, stoichiometries generally are only approximate quantities. In particular, materials can have contaminants, defects and the like. Similarly, some amorphous materials can comprise essentially blends such that the relative amounts of different components are continuously adjustable over ranges in which the materials are miscible. In other embodiments, phase separated amorphous materials can be formed with differing compositions at different domains due to immiscibility of the materials at the average composition. Furthermore, for amorphous and crystalline materials in which metal/metalloid compounds have a plurality of oxidation states, the materials can comprise a plurality of oxidation states. Thus, when stoichiometries are described herein, the actual materials may comprise other stoichiometries of the same elements also, such as SiO₂ also include some SiO and the like.

With respect to the electrical properties of the particles, some particles include compositions such that the particles are electrical conducting, electrical insulators or electrical semiconductors. Suitable electrical conductors include, for example, elemental metals and some metal compositions. Electrical conductors, such as metals, generally have a room temperature resistivity of no more than about 1×10⁻³ Ohm-cm. Electrical insulators generally have a room temperature resistivity of at least about 1×10⁵ Ohm-cm. Electrical semiconductors include, for example, silicon, CdS and InP. Semiconducting crystals can be classified to include so called, II-VI compounds, III-V compounds and group IV compounds, where the number refers to the group in the periodic table. Semiconductors are characterized by a large increase in conductivity with temperature in pure form and an increase in electrical conductivity by orders of magnitude upon doping with electrically active impurities. Semiconductors generally have a band gap that results in the observed conductivity behavior. At room temperature, the conductivity of a semiconductor is generally between that of a metal and a good electrical insulator.

In some embodiments, powders comprise as a host material, for example, silicon particles, metal particles, and metal/metalloid compositions, such as, metal/metalloid oxides, metal/metalloid carbides, metal/metalloid nitrides, metal/metalloid phosphides, metal/metalloid sulfides, metal/metalloid tellurides, metal/metalloid selenides, metal/metalloid arsinides and mixtures and combinations thereof. Especially in amorphous materials, great varieties of elemental compositions are possible within a particular material. Suitable glass forming host oxides for doping include, for example, TiO₂, SiO₂, GeO₂, Al₂O₃, P₂O₅, B₂O₃, TeO₂, CaO—Al₂O₃, V₂O₅, BiO₂, Sb₂O₅ and combinations and mixtures thereof.

In addition, particles can comprise one or more dopants/additives within an amorphous material and/or a crystalline material. Dopant(s)/additive(s), which can be complex blends of dopant/additive composition(s), generally are included in non-stoichiometric amounts. A dopant/additive is generally metal or metalloid element, although other dopant(s)/additive(s) of interest include fluorine, chlorine, nitrogen and/or carbon, which substitute for oxygen in oxides or other anions relative to metal/metalloid components. The dopant(s)/additive(s) generally can replace other constituents within the material in order to maintain overall electrical neutrality. Dopant(s)/additive(s) can impart desirable properties to the resulting materials. The amount of dopant(s)/additive(s) can be selected to yield desired properties while maintaining appropriate chemical stability to the material. In crystalline materials, dopant/additive element(s) can replace host elements at lattice sites, dopant/additive element(s) can reside at previously unoccupied lattice sites and/or dopant/additive element(s) can be located at interstitial sites. Unlike dopant(s)/additive(s) within crystalline materials in which the crystal structure influences incorporation of the dopant(s)/additive(s), dopant(s)/additive(s) within amorphous materials can behave more as a composition dissolved within the host material to form a solid mixture. Thus, the overall composition of the material influences the chemical properties, including the processing parameters and stability, of the resulting combined materials.

An inorganic composition generally comprises a dopant in the range no more than about 15 mole percent of the metal/metalloid in the composition, in further embodiments in the range no more than about 10 mole percent, in some embodiments in the range from about 0.001 mole percent to about 5 mole percent, and in other embodiments in the range from about 0.025 to about 1 mole percent of the metal/metalloid in the composition. A person of ordinary skill in the art will recognize that additional ranges within the explicit ranges of dopant concentrations are contemplated and the present disclosure similarly covers ranges within these specific ranges. Additive compositions are similar to dopant compositions except that they generally are included at higher amounts while still being a minority component of the composition, i.e., in the range(s) less than about 50 mole percent of the composition. Additive(s) can be useful for many of the same purposes as dopant(s). Doped and doping, for convenience, can refer to materials with dopants and/or additives and the process of incorporating dopants and/or additives, respectively.

Powders, e.g., collections of inorganic particles, can be formed with complex compositions including, for example, one or more metal/metalloid elements in a host material and, optionally, one or more selected dopants/additives. With laser pyrolysis, materials can be formed with desired compositions by appropriately introducing a reactant composition to form the desired host material. Specifically, selected elements can be introduced at desired amounts by varying the composition of the reactant stream. The conditions in the reactor can also be selected to produce the desired materials.

In some embodiments, suitable dopant(s)/additive(s) include, for example, metal/metalloid elements, such as rare earth metals. Rare earth dopants can impart desirable modifications of properties, such as index-of-refraction, photosensitivity, fluorescence and paramagnetism. For example, the rare earth dopant(s)/additive(s) can influence the optical emission properties that can alter the application of the materials for the production of optical amplifiers and other optical devices. Rare earth metals comprise the transition metals of the group IIIb of the periodic table. Specifically, the rare earth elements comprise Sc, Y and the Lanthanide series. Other suitable dopant(s)/additive(s) include elements of the actinide series. For some embodiments, the rare earth metals of interest as dopants/additives comprise Er, Yb, Nd, La, Ce, Th, Dy, Ho, Sm, Eu, Gd, Pr, Tm, Sc, Y, and the like and combinations thereof Suitable non-rare earth metal dopants/additives include, for example, Al, Ga, Mg, Sr, Zn, Bi, Sb, Zr, Pb, Li, Na, K, Ba, W, Si, Ge, P, B, Te, Ca, Rb, Sn, In, Ti, Au, Ag, Ta, Mo, Nb, and the like and combinations thereof. Also, certain first-row transition metals have optical emission properties in the visible or infrared regions of the spectrum. Suitable first-row transition elements having desirable optical properties as dopants/additives include, for example, V, Cr, Mn, Fe, Co, Ni and Cu. The wavelength of the optical emission depends on the oxidation-state of the transition-metal.

With respect to laser pyrolysis, the production of a large range of inorganic particle compositions has been described. For example, the production of a range of submicron inorganic particles are described in Published U.S. Patent Application 2003/0203205 to Bi et al., entitled Nanoparticle Production and Corresponding Structures,” incorporated herein by reference. Specifically, this published application specifically references production of amorphous SiO₂, anatase and rutile TiO₂, MnO, Mn₂O₃, Mn₃O₄ and Mn₅O₈, vanadium oxide submicron/nanoscale particles, silver vanadium oxide submicron/nanoscale particles lithium manganese oxide submicron/naooscale particles, lithium cobalt oxide, lithium nickel oxide, lithium cobalt nickel oxide, lithium titanium oxide and other lithium metal oxides, aluminum oxide submicron/nanoscale particles, tin oxide particles zinc oxide particles rare earth metal oxide, rare earth doped metal/metalloid oxide, α-Fe, Fe₃C, and Fe₇C₃, iron oxide, silver metal, iron sulfide (Fe₁₋ₓS) particles, metal phosphate particles, silicon carbide, silicon nitride and other compositions.

In general, the surface chemistry of the particle cannot be directly observed, but it can be indirectly evaluated. For example, an elemental analysis can be performed to detect the presence of halogen atoms or other atoms that are not part of the particle core. Infrared spectroscopy can be used to measure the bonding at the particle surfaces. Also, the behavior of the particles with respect to dispersion in different solvents/dispersants can provide information regarding the particle surface chemistry.

### In-Flight Particle Manipulation Processes

The in-flight particle manipulation processes described herein take place along the flow between a light reaction zone of the laser pyrolysis apparatus and a particle collector. The inorganic particles are formed within or immediately downstream from the light reaction zone. Along the flow, one or more modification stations introduce a composition generally under strongly mixing conditions. The composition can be, for example, an inert gas or a surface chemistry modifying composition. In some embodiments, the flow is cooled with a strongly mixing inert gas prior to collection. Through the various combinations of processes, the properties of the particles can be engineered such that particle collections are harvested with desired properties.

Apparatus features are described above for the introduction of strongly mixing injected compositions for interaction with the product inorganic particle flow. The mixing process should not depend on the type of reaction used to form the inorganic particles, although the inorganic particle formation process itself is generally strongly dependent on the type of reactor. There is no need to precisely evaluate the boundaries of the mixing parameters for desired levels of mixing. An approach to estimate roughly the boundaries for high momentum-driven turbulent mixing is described above with respect to the laser pyrolysis apparatus above. In general, one can use smaller inlet areas with correspondingly higher flow pressures to achieve desired degrees of mixing for a selected quantity of mixing composition. Similarly, for a particular apparatus design, a higher flow through the mixing inlets can be used to achieve a desired degree of mixing. To obtain the desired degree of mixing, a pressurized flow of mixing composition is generally used. This mixing composition correspondingly also can reduce agglomeration without more since the translational energy of the mixture generally is increased.

In general, if the engineering of the product particles first involves obtaining the desired crystal structure and if the kinetics of this crystal formation is slower than particle formation and densification, then the time scale of crystallinity development then becomes a significant consideration within any particular process. Thus, the flow can be first modified to induce the desired crystal structure. In particular, heated inert gas can be introduced into the flow to slow or reverse the quenching of the flow so that the crystal structure can continue developing under low agglomeration conditions. In some embodiments, samples can be taken from the reactor to evaluate the time scale of the crystal structure development. The time scale strongly depends on the particle properties, such as size, stoichiometry and materials in the particle, as well as the particular crystal structure.

Once the desired crystal structure has evolved to a desired high degree of crystallinity, the flow can be further modified and/or fully quenched. Further modification can comprise modifying the surface chemistry. The surface chemistry modification generally comprises the introduction of an appropriate composition to react with the particle surface to modify the surface chemistry as desired. Also, the composition can be introduced under appropriate conditions to induce the surface modification. For example, the surface modification composition can be heated prior to mixing into the flow if a heated reactant composition reacts more quickly to modify the surface chemistry. Heterogeneous vapor deposition on particle surfaces generally occurs at temperatures lower than homogenous nucleation of new particles. Alternatively, the flow can be heated with inert gas at a separate modification station prior to introduction of the surface modifying composition. Also, the surface modification composition can be diluted with an inert gas, if desired, to achieve desired total flow rates and desired thermal manipulation with respect to the mixed flow.

Following any crystal structure manipulation and any surface chemistry manipulation, it can be desirable to mix cooling gas with the flow to cool the particles prior to reaching the collector. In particular, since the particles amass at the collector, it is desirable for the temperature at the collector to not get too high or to stay high for long periods of time. For example, if the temperature gets too high the particle properties can be influenced and the collector can be adversely affected. The components of the collector can also be cooled with appropriate water jackets or other cooling approaches. The amount of cooling gas can be selected to provide the desired degree of cooling. With respect to the apparatus in FIGS. 8-11, cooling gas can be introduced in collar 504 and/or with one or more of mixing stations 510, 512, 514, 516.

### EXAMPLES

### Example 1

### Rutile Titanium Oxide with In Situ Cooling

This example demonstrates that the surface area of the collected particles can be increased through the addition of unheated inert gas into the product flow a short distance downstream from the light reaction zone.

Laser pyrolysis was carried out using a reaction chamber similar to the apparatus described above with respect to FIGS. 8 and 9. The chamber is designed to add additional inert gas to the flow following particle formation to cool the particles and dilute the particle stream. A filter collector was used in batch run operation. Various quantities of dilution gas (nitrogen) was introduced 3.5 cm downstream of the laser beam through an array of ten opposing jet pairs, each pair comprised of two 1 mm diameter nozzle openings situated across a 2.54 cm gap in a rectangular-shaped manifold. Both arrays of the 10 jets per side of the manifold were fed by one gas stream that was controlled using a pair of mass flow controllers (MFCs). At the plane of introduction, the manifold dimensions are approximately 12 cm by 2.54 cm. The long manifold dimensions decrease in the downstream direction while the short dimension increases until the manifold is mated to cylindrical tubing.

Titanium tetrachloride (>98% pure) was delivered from a flash evaporator. C₂H₄ gas was used as a laser absorbing gas, and argon was used as an inert diluent gas. The reactant mixture containing the titanium precursor, Ar, O₂ and C₂H₄ was introduced into the reactant nozzle for injection into the reaction chamber. Additional parameters of the laser pyrolysis synthesis relating to the particles of Example 1 are specified in Table 1. Several sets of experiments were performed under each set of conditions.

TABLE 1

| | 1 | 2 |
|---|---|---|
| TiCl₄ (PPM) | 5000 | 5000 |
| Pressure (Torr) | 50 | 50 |
| Nitrogen - Window (SLM) | 5.0 + 5.0 | 5.0 + 5.0 |
| Argon -Shielding (SLM) | 4.00 | 3.50 |
| Ethylene (SLM) | 1.15 | 0.55 |
| Diluent Gas (Argon) (SLM) | 0.50 | 1.61 |
| Oxygen (SLM) | 1.50 | 1.10 |
| Laser Input (Watts) | 1500 | 1500 |
| Laser Output (Watts) | 1455 | 1480 |

Eight samples were run under the conditions in the first column in Table 1 and eight samples were run under the conditions in the second column in Table 1. The amounts of inert gas, specifically N₂, were adjusted to determine the effects of cooling the product particle flow through the introduction of room temperature inert gas under strong mixing conditions.

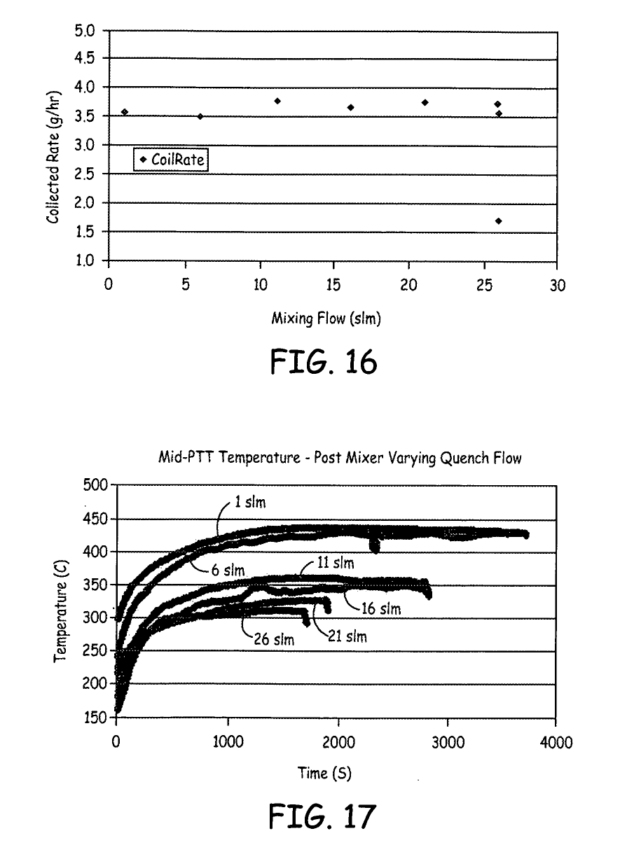

As shown in FIG. 16, the product particle collection rate was effectively independent of the volume of inert gas injected into the product flow, although there was significant batch to batch fluctuations presumably do to complications of collecting the powders from the filters. The temperature measured using a thermocouple mounted 7.5 centimeters from the light reaction zone in the flow conduit is plotted in FIG. 17. The temperature roughly reached a steady state as a function of time. As can be seen from the plots, a significant temperature drop is measured as a result of injecting the inert gas into the flow, and the use of larger volumes of inert gas results in corresponding lower temperatures.

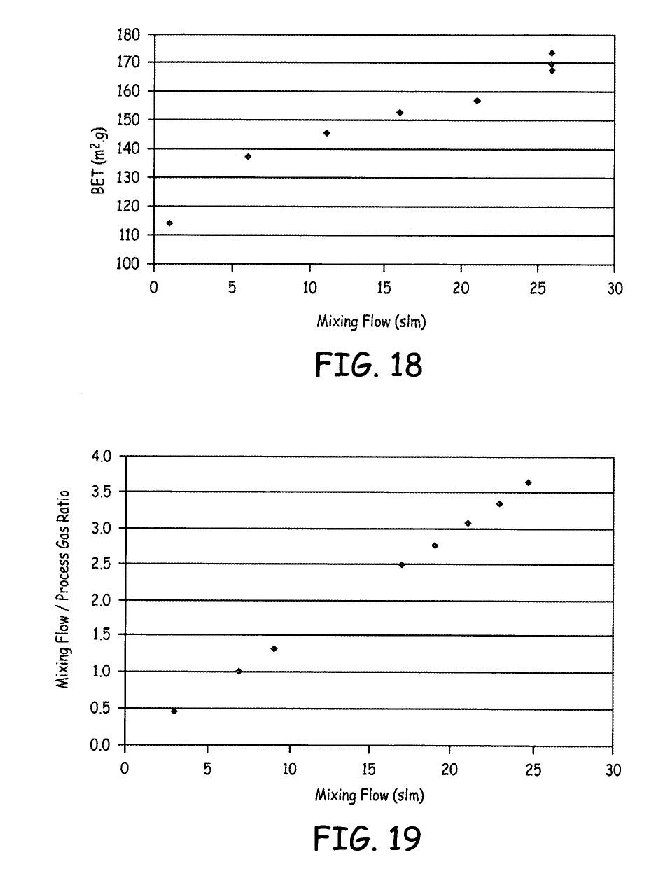

BET surface were measured using conventional techniques using gas adsorption. The BET surface area of the powders is plotted in FIG. 18. As increased volumes of cooling gas are introduced, the surface area of the powder increases. Since experience over many years has indicated that non-porous particles are formed under these conditions in a laser pyrolysis reactor, the increase in surface area can be correlated with a corresponding decrease in average particle size. This indicates that particle growth and/or particle agglomeration is decreased as a result of the introduction of the cooling gas.

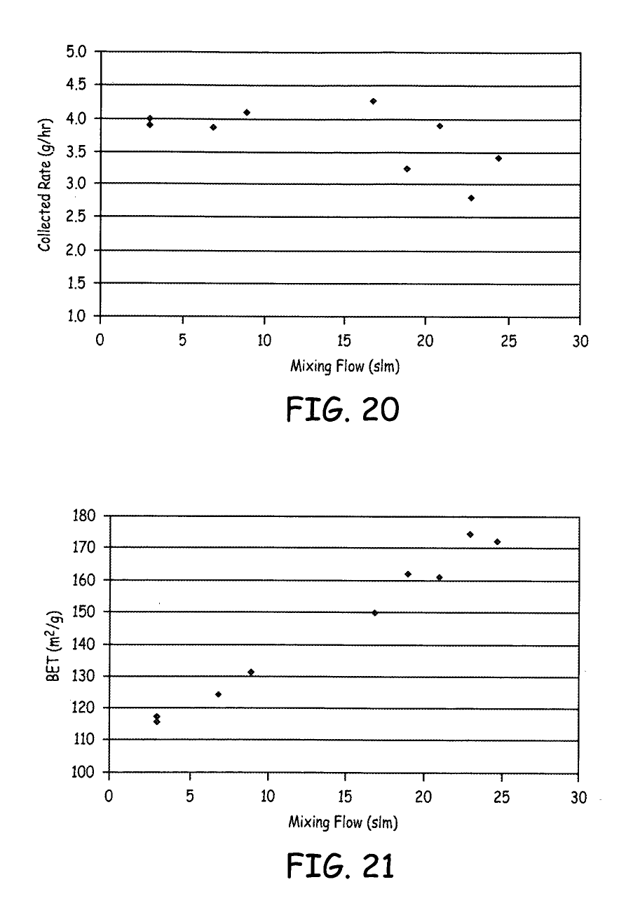

For the runs performed under the conditions of the second column of Table 1, the ratio of the mixing flow divided by the particle synthesis production gas as a function of mixing flow is plotted in FIG. 19. The collection rate was again roughly independent of the mixing flow, as plotted in FIG. 20, although there was significant batch to batch fluctuation presumably related to experimental error related to issues of collecting the powder from the filter. Again, the particle surface area increased with increasing mixing flow, as plotted in FIG. 21. Again, this indicates that the particle size decreases with increased mixing flow.

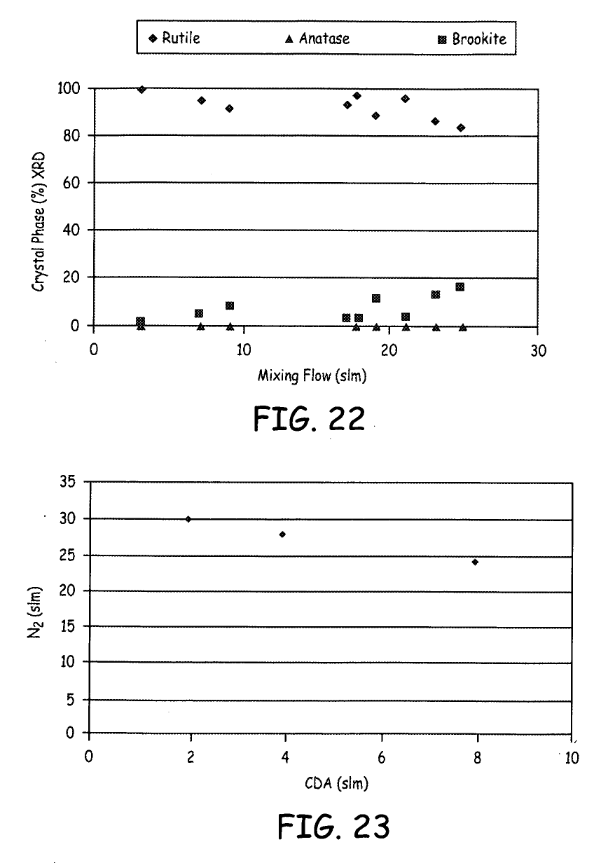

To evaluate the atomic arrangement, samples were examined by x-ray diffraction using the Cr(_{Kα}) radiation line on a Rigaku Miniflex x-ray diffractometer. In each of the samples, crystalline phases were identified that corresponded to specific crystal phases of TiO₂ by comparison with known diffractograms. The amount of anatase, rutile and brookite crystal phases was determined for each of the TiO₂ powder samples. The results are plotted in FIG. 22. The phase percentage of rutile appears to decrease with increasing quantity of diluent gas, while the phase percentage of brookite appears to be increasing.

### Example 2

### Addition of Unheated CDA As a Surface Modifying Reagent

This example demonstrates the mixing of a surface modifying composition with the product flow within the flow conduit.

The experiments in this example were performed in the same apparatus as used in Example 1. Various quantities of dilution gas (nitrogen) and clean dry air (CDA), 20% O₂ by volume, was introduced 3.5 cm downstream of the laser beam through an array of ten opposing jet pairs, each pair comprised of two 1 mm diameter nozzle openings situated across a 2.54 cm gap in a rectangular-shaped manifold. Both arrays of the 10 jets per side of the manifold were fed by one gas stream that was controlled using a pair of MFCs. At the plane of introduction, the manifold dimensions are approximately 12 cm by 2.54 cm. The long manifold dimensions decrease in the downstream direction. The clean dry air was produced by passing room air through a compressor drier assembly including 0.1 μm filtration and silica-based desiccation to produce CDA with −40 C dew point.

The reactant flow was formed using the compositions described above with respect to Example 1. The specific reaction parameters are summarized in Table 2.

TABLE 2

| | 1 | 2 |
|---|---|---|
| TiCl₄ (PPM) | 5000 | 6000 |
| Pressure (Torr) | 50 | 50 |
| Nitrogen - Window (SLM) | 5 + 5 | 5 + 5 |
| Argon -Shielding (SLM) | 4.5 | 5.5 |
| Ethylene (SLM) | 0.80 | 1.1 |
| Diluent Gas (Argon) (SLM) | 1.65 | 1.8 |
| Oxygen (SLM) | 1.60 | 2.2 |
| Laser Input (Watts) | 1475 | 1470 |
| Laser Output (Watts) | 1455 | 1460 |

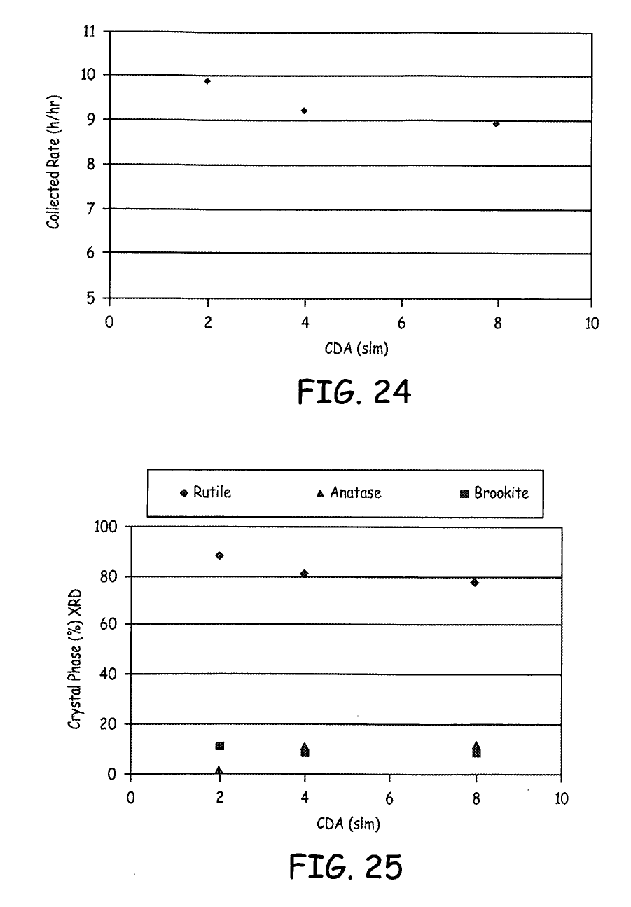

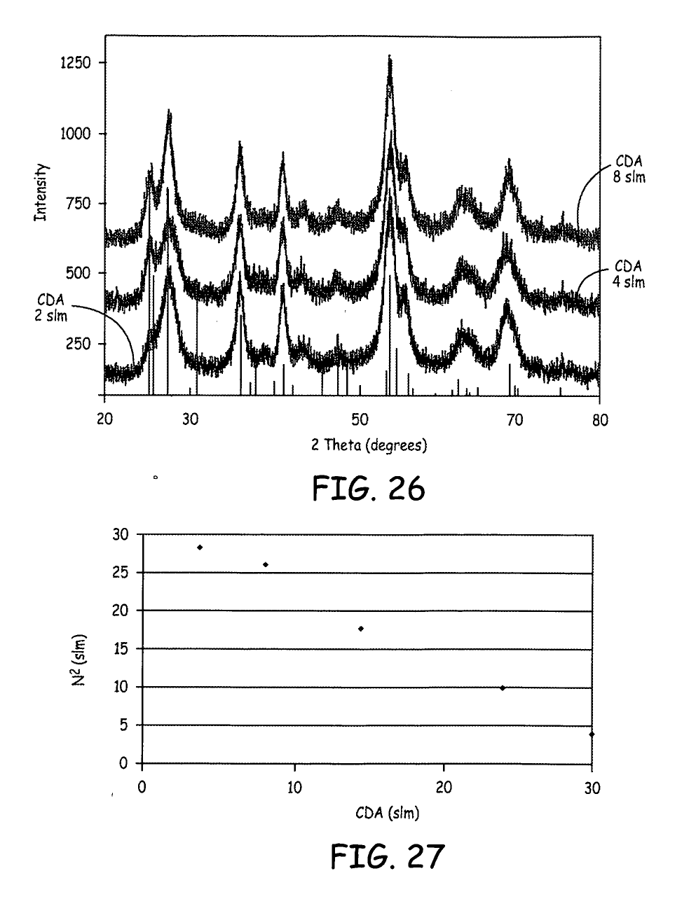

Three runs were performed under the conditions of the first column of Table 2. Five runs were performed under the conditions in the second column of Table 2. In both sets of runs, the total mixing gas used for each run was 32 slm. The break down between N₂ and clean dry air for the three runs is shown in the plot of FIG. 23. The powder collection rate varied somewhat in the runs as shown in the plot in FIG. 24, although the variation between these runs was thought to be less the experimental error for the manual powder collection from the filters.

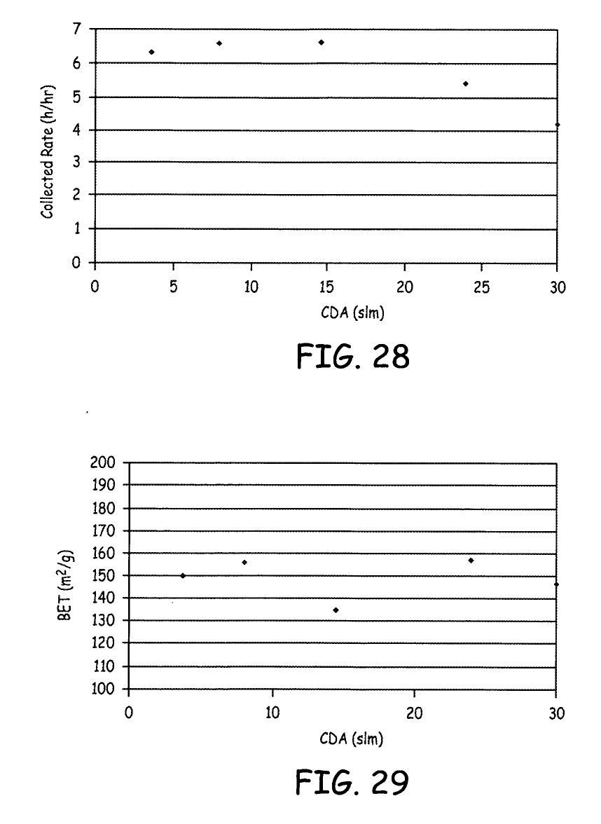

X-ray diffractograms were taken for each of the samples. The diffractograms were used to evaluate the crystal structures of the resulting powders. The results are plotted in FIG. 25. There appears to be a systematic decrease in rutile percentage as the amount of CDA is increased. For the second set of samples based on the parameters in the second column of Table 2, the total mixing flow was approximately 32 slm. The amount of N₂ and clean dry air (CDA) for each run is shown in FIG. 27. For three of the runs, larger amounts of clean dry air were used in comparison with the amounts plotted in FIG. 23. As plotted in FIG. 28, there was some variation in the powder collection rates, but the variation again may not have been significant relative to the experimental error. The BET surface area is plotted in FIG. 29 as a function of the amount of clean dry air mixed into the flow. While there is some scatter in the surface area values, there is no clear trend as a function of amount of clean dry air.

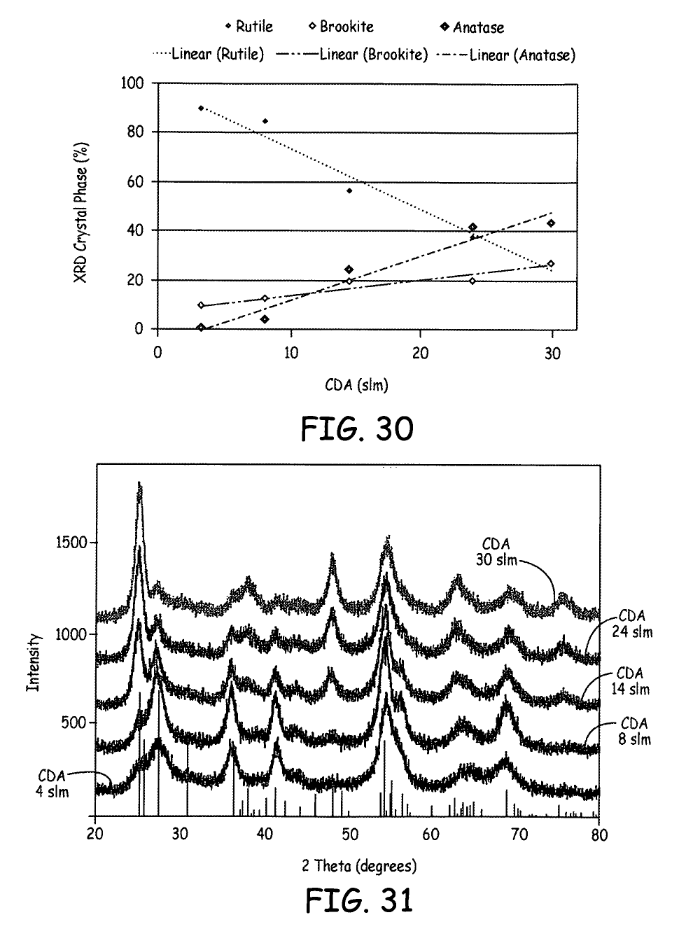

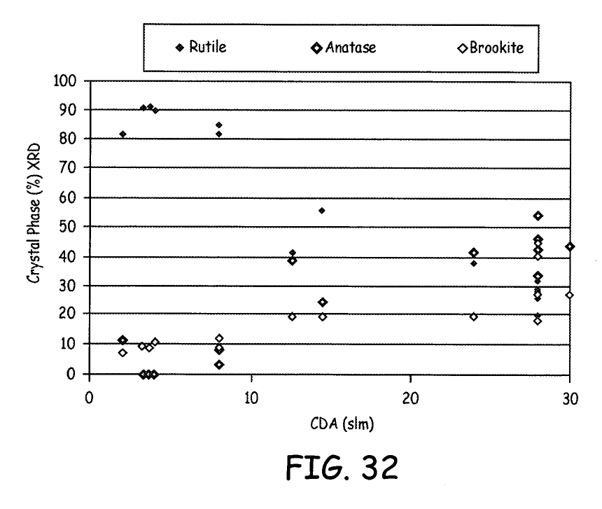

Again, x-ray diffractograms were obtained for the samples. For these samples, the mixing gas had a very significant effect on the crystalline phase of the powders. In particular, the introduction of greater amounts of air resulted in a significant loss of the rutile crystalline phase. The results are plotted in FIG. 30. The diffractogram plots are given in FIG. 31. Upon a repeat of these experiments, the trends were confirmed, as shown in the plot in FIG. 32.

### Example 3

### Addition of Fast Mixing Heated Gas as a Particle Modifying Strategy

This example demonstrates the mixing of preheated gas with the product flow within the flow conduit.

The experiments in this example were performed in the same apparatus as used in Example 1. Nitrogen, preheated to 650 C, was mixed into the product flow using the same modification element and placement as above. I.e., various quantities of dilution gas (nitrogen) was introduced 3.5 cm downstream of the laser beam through an array of ten opposing jet pairs, each pair comprised of two 1 mm diameter nozzle openings situated across a 2.54 cm gap in a rectangular-shaped manifold. Both arrays of the 10 jets per side of the manifold were fed by one gas stream that was controlled using a pair of MFCs. At the plane of introduction, the manifold dimensions are approximately 12 cm by 2.54 cm. The long manifold dimensions decrease in the downstream direction while the short dimension increases until the manifold is mated to cylindrical tubing.

The reactant flow was formed using similar compositions already described in Table 1 Column 2 in Example 1, but with a precursor increase of 50% and 2 slm less shielding. The specific reaction parameters are summarized in Table 3.

TABLE 3

| | 1 |
|---|---|
| TiCl₄ (PPM) | 7500 |
| Pressure (Torr) | 50 |
| Nitrogen - Window (SLM) | 5 + 5 |
| Argon -Shielding (SLM) | 2.60 |
| Ethylene (SLM) | 1.10 |
| Diluent Gas (Argon) (SLM) | 1.20 |
| Oxygen (SLM) | 0.55 |
| Laser Input (Watts) | 1515 |
| Laser Output (Watts) | 1400 |

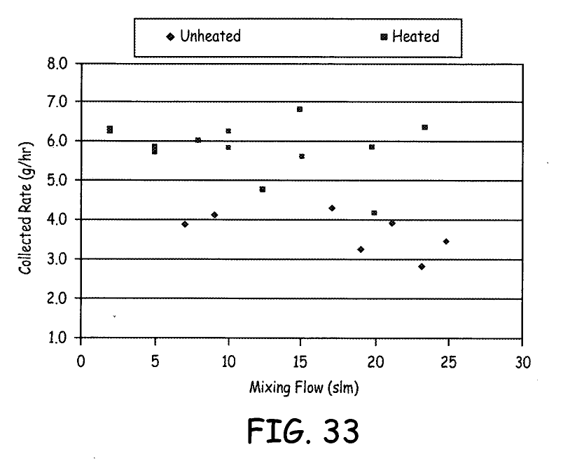

Eleven runs were performed under the conditions of the first column of Table 3 Column 1. The powder collection rate is plotted in FIG. 33 (Heated) alongside those from Table 1 Column 2 (Unheated). The collection rate is consistent with the increased precursor flowrate, and it varied somewhat in the runs, although the variation between these runs was thought to be less the experimental error for the manual powder collection from the filters.

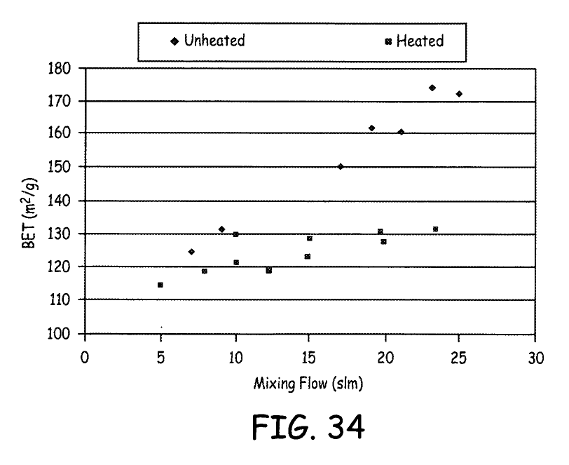

BET surface areas were measured using conventional techniques based on gas adsorption. The BET surface area of the same two datasets (Heated and Unheated) of powders is plotted in FIG. 34. As increased volumes of mixing gas are introduced, the surface area of the powder increases. Since a large body of experience has indicated that non-porous particles are formed under these conditions in a laser pyrolysis reactor, the increase in surface area can be correlated with a corresponding decrease in average particle size. This indicates that particle growth and/or particle agglomeration is decreased as a result of the introduction of the mixing gas. The increase in BET surface area of the “Heated” sample is less dramatic than the “Unheated” sample, suggesting that some densification may still occur with the additional heat available.

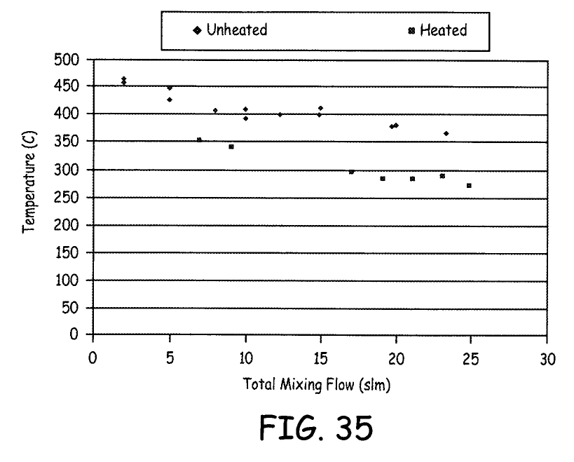

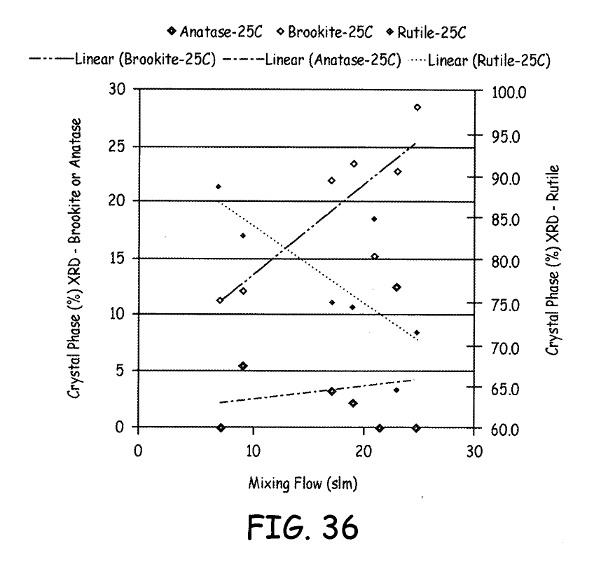

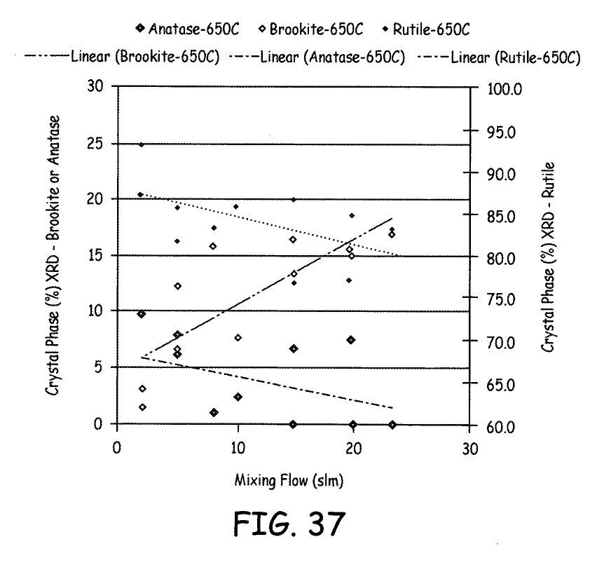

In FIG. 35, the steady state temperature measured approximately 7.5 cm downstream of the laser reaction zone is shown for both the “heated” (Table 3, Column 1) and “unheated” (Table 1, Column 2) samples. It is clearly seen that the heat loss between the externally mounted packed bed heater and the reaction chamber failed to raise the temperature by more than 175 C for any similarly constructed mixing flow experiment. The crystalline phases as a function of mixing flow are plotted in FIG. 36. As shown in FIG. 37, the additional heat is observed to have a beneficial effect in increasing the percentage of rutile phase in the TiO₂ powder. This effect is likely greater than observed herein, as experimental data typically shows that the percentage of rutile tends to decrease in a steadily maintained process gas environment as the fraction of precursor is increased.

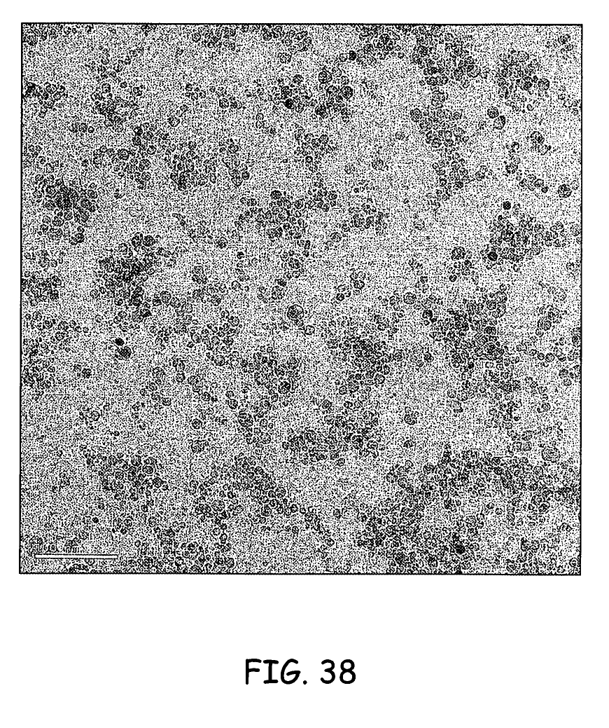

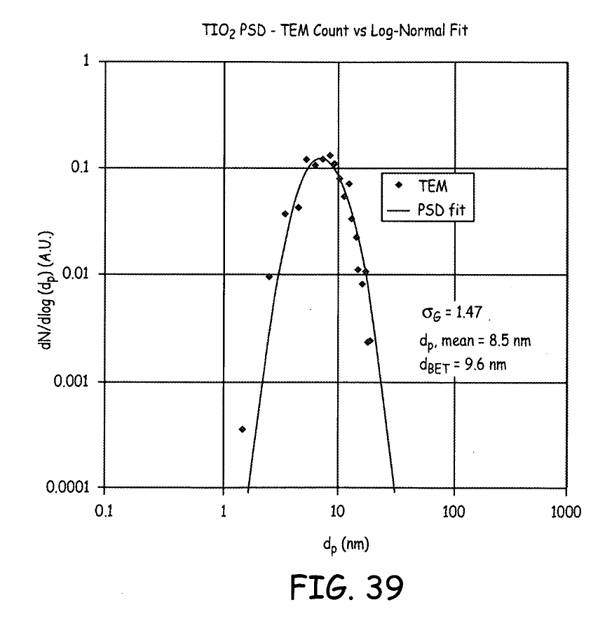

A representative transmission electron micrograph is shown in FIG. 38 for TiO₂ particles having a surface area of 147 m²/g collected with unheated cooling gas. The particle size distribution for this sample is plotted in FIG. 39 as a function of the log of the particle diameter. A log-normal least squares fit is plotted in FIG. 39 along with the data points.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A reactor comprising:
a reaction chamber;
a precursor delivery system comprising an inorganic precursor source operably connected to a nozzle directed into the reaction chamber wherein the nozzle has a non-circular opening characterized by an elongated dimension;
a light source configured to deliver a beam of light through the reaction chamber to intersect with flow from the nozzle at a light reaction zone;
a product flow conduit having a non-circular cross section characterized by elongated sides and a width between the elongated sides, wherein the conduit is configured to receive a particulate product flowing from the light reaction zone; and
a first modification element configured to direct a mixing flow into the product flow conduit, the first modification element comprising one or more inlets connected to a fluid source wherein the total area of the inlets is no more than about 0.15 times the cross section of the product flow conduit at the first modification element.

2. The reactor of claim 1 wherein the light source is an infrared laser.

3. The reactor of claim 1 wherein the reaction chamber conforms generally to the shape of the nozzle.

4. The reactor of claim 1 further comprising a particle collector downstream from the first modification element and a pump downstream from the particle collector to maintain flow through the reactor.

5. The reactor of claim 1 wherein the first modification element is configured to deliver inert gas from the fluid source at a temperature higher than ambient room temperature to add heat to a product particle flow.

6. The reactor of claim 1 wherein the first modification element is configured to deliver inert gas from the fluid source at a temperature lower than ambient room temperature to reduce the average thermal energy of the product particle flow.

7. The reactor of claim 1 further comprising a second modification element comprising one or more inlets displaced along the product flow from the first modification element.

8. The reactor of claim 1 wherein the one or more inlets of the first modification element is fluidly connected to an inert gas source and the one or more inlets of the second modification element is fluidly connected to a surface modifying composition source.

9. The reactor of claim 1 wherein the nozzle opening has an aspect ratio of at least 5 with respect to the elongated dimension relative to the thickness.

10. The reactor of claim 1 wherein the product flow conduit is a section of the reaction chamber downstream from the light reaction zone.

11. The reactor of claim 1 further comprising a particle transport section connecting the reaction chamber and a particle collector to form a flow path for product particles from the light reaction zone to the collector, wherein the modification section is interfaced with the particle transport section.

12. The reactor of claim 1 wherein a first modification element comprising a first set of jets with at least four jets operably connected to the fluid source, the jets being configured to mix fluid from the jets with product particle flow within the particle flow conduit wherein the jets are configured along the elongated sides and the jets each have a diameter no more than about 0.25 times the distance between adjacent elongated sides at the position of the jets.

13. The reactor of claim 1 wherein the first modification element comprises at least ten jets located symmetrically in pairs along the elongated sides.

14. The reactor of claim 1 wherein the first modification element comprises two knife inlets oriented opposite each other on the respective opposite elongated sides of the product flow conduit.

15. A method for moderating the temperature of flow of product particles in a reactor to control the crystal structure of the product particles, the method comprising mixing inert gas with a product particle flow wherein the temperature of the inert gas is selected to achieve a desired particle crystal structure and wherein the particles are synthesized within the flow by the reaction of a reactant flow with the reaction driven by an intense light beam at a light reaction zone and wherein the flow proceeds from a reactant inlet through the light reaction zone with the product particles continuing in the flow to a particle collector wherein the measurable crystal structure of the collected particles is changed by the mixing with the inert gas.

16. The method of claim 15 wherein the inert gas is heated to a selected temperature to heat the flow to support the formation of a desired crystalline phase of the product particles.

17. The method of claim 15 wherein the inert gas is introduced through a plurality of inlets that mix the inert gas with the flow, wherein the inlets are positioned in a flow channel along elongated sides of the flow channel and wherein the area of the inlets is no more than about 0.15 times the cross sectional area of the flow channel at the inlets.

18. The method of claim 17 wherein the inlets comprise a set of at least about 8 jets wherein the jets have a diameter of no more than about 0.25 times the distance between adjacent elongated sides.

19. The method of claim 17 wherein the inlets comprise at least two knife slits.

20. The method of claim 17 wherein the total flow rate from the inlets being at least about 0.25 of the product flow rate leading to the mixing location and wherein the jet flow rate and jet diameters being selected to provide good mixing as determined by an improvement in the uniformity of the collected particles.

21. The method of claim 15 wherein the final product particles comprise rutile TiO₂.

22. A method for modifying the surface chemistry without coating the particles, the method comprising mixing a selected composition with a product particle flow wherein the composition is selected change the chemical properties of the flow to result in modified surface chemistry of the inorganic particles and wherein the particles are synthesized within the flow by the reaction of a reactant flow with the reaction driven by an intense light beam at a light reaction zone and wherein the flow proceeds from a reactant inlet through the light reaction zone with the product particles continuing in the flow to a particle collector.

23. The method of claim 22 wherein the selected composition is introduced through a plurality of inlets that mix the inert gas with the flow in a flow channel having a cross sectional area, wherein the inlets are positioned in a flow channel along elongated sides of the flow channel and wherein total area of the inlets is no more than a factor of 0.15 times the cross sectional area of the flow channel.

24. The method of claim 22 wherein the product particles comprise a metal/metalloid oxide and wherein the selected composition comprises water.

25. The method of claim 22 wherein the product particles comprise a metal/metalloid oxide and wherein the selected composition comprises a halogen atom.
